(19) United States
(12) Patent Application Publication
(10) Pub. No.: US 2025/0010109 A1
(43) Pub. Date: Jan. 9, 2025

(54) SYSTEMS AND METHODS FOR ADSORPTION CAPACITY ESTIMATION

(71) Applicant: 3M INNOVATIVE PROPERTIES COMPANY, St. Paul, MN (US)

(72) Inventors: Frank Ding, Waxhaw, NC (US); Darin K. Thompson, Huntersville, NC (US); Daniel B. Taylor, White Bear Lake, MN (US); Steven T. Awiszus, Woodbury, MN (US); Wenli Wang, Woodbury, MN (US); Kevin A. Frankel, Woodbury, MN (US); Dong Fu, Woodbury, MN (US); Richard C. Webb, St. Paul, MN (US); Lisa M. Croll, Ontario (CA)

(21) Appl. No.: 18/712,316

(22) PCT Filed: Dec. 2, 2022
(86) PCT No.: PCT/IB2022/061695

§ 371 Date: May 22, 2024

Related U.S. Application Data
(60) Provisional application No. 63/264,851, filed on Dec. 3, 2021.

(51) Int. Cl. A62B 18/08; A62B 9/00

(52) U.S. Cl. CPC A62B 18/088; A62B 9/006

(57) ABSTRACT

A filter remaining capacity detection system is presented that includes a parameter retriever that retrieves parameter information for an atmosphere around the filter. The system also includes an adsorption estimate generator that, based on the parameter information retrieved, solves a set of controlling equations to generate an adsorption estimate. The controlling equations are a set of mass and energy balance equations. The system also includes a remaining capacity detector that, based on the adsorption estimate, generates a remaining capacity estimate. The system also includes a signal generator that generates a signal if the remaining capacity estimate is below a threshold.

### BACKGROUND

Maintaining the safety and health of workers is a major concern across many industries. Various rules and regulations have been developed to aid in addressing this concern. Such rules provide sets of requirements to ensure proper administration of personnel health and safety procedures. To help in maintaining worker safety and health, some individuals may be required to don, wear, carry, or otherwise use a personal protective equipment (PPE) article, if the individuals enter or remain in work environments that have hazardous or potentially hazardous conditions. In environments where the atmosphere contains toxic chemicals, workers need to wear PPE with a filtering system to make the air safe to breath.

Consistent with evolving rules and regulations related to safety, safety is an important concern in any workplace requiring the use of PPE. Companies or businesses employing workers wearing articles of PPE also want to ensure that workers are complying with relevant laws, regulations and company policies related to proper use and maintenance of PPE.

A variety of air purification systems have been developed to protect people from hazardous air contaminants. Among these air purification systems are a wide range of air purifying respirators that are designed to filter out and/or sorb contaminants present in the air. Upon use of the respirator, the contaminants become captured and absorbed or adsorbed by the respirator. Eventually, the ability of the respirator to remove the hazardous air contaminants begins to diminish.

During extended exposure to an environment containing hazardous air contaminants, such as, for example, continuous or repeated worker exposure to such environments, techniques are necessary to determine the useful service life of a respirator. One technique that has been developed is based upon the time in service for a respirator. In this technique, respirators or the air purifying filters are replaced after a certain period of time in service. However, this technique does not take into account variations in contaminant level or flow rates through the respirator and therefore may result in the respirator or filter elements being changed too early (which is wasteful) or too late (which may present a danger to the user).

### SUMMARY

A filter remaining capacity detection system is presented that includes a parameter retriever that retrieves parameter information for an atmosphere around the filter. The system also includes an adsorption estimate generator that, based on the parameter information retrieved, solves a set of controlling equations to generate an adsorption estimate. The controlling equations are a set of mass and energy balance equations. The system also includes a remaining capacity detector that, based on the adsorption estimate, generates a remaining capacity estimate. The system also includes a signal generator that generates a signal if the remaining capacity estimate is below a threshold.

The details of one or more examples of the disclosure are set forth in the accompanying drawings and the description below. Other features, objects, and advantages of the disclosure will be apparent from the description and drawings, and from the claims.

### BRIEF DESCRIPTION OF THE DRAWINGS

FIGS. 1A-1B illustrate a PPE device in which embodiments herein may be useful.

FIG. 2 illustrates a method of generating a concentration profile for a filter in accordance with embodiments herein.

FIG. 3 illustrates a filter loading simulation system in accordance with embodiments herein.

FIG. 4 illustrates a mobile simulation device in one embodiment of the present invention.

FIG. 5 illustrates a worksite in which embodiments of the present invention may be useful.

FIG. 6 illustrates a concentration profile simulation system architecture.

FIGS. 7-9 illustrate example devices that can be used in embodiments herein.

FIGS. 10A-10D illustrate Example filter capacity estimates.

### DETAILED DESCRIPTION

Manually monitoring PPE use in a given workplace can be cumbersome and time consuming for supervisors or safety compliance officers. Improved methods and systems for monitoring safety compliance, PPE maintenance, and providing safety-related contextual information in a work environment requiring the use of PPE are needed.

As described herein, in some environments, the air around a worker in a workplace may be contaminated with toxic chemicals or hazardous particles that maybe dangerous to the workforce. It is important for workers, as well as safety compliance officers, to know when a filter responsible for filtering air for a worker must be replaced. Currently users either change out their filter based on estimates using generic or supplier provided tools or, when estimations are not available sometimes, change out based on taste or smell. This brings its own challenges in that many containments have low odor and taste thresholds, and user may lose olfactory sensitivity over time. There are many different factors contributing to determining when a given filter cartridge is used up. For example, temperature, relative humidity and air pressure of the site atmosphere, a flow rate (a function of breathing rate and the tidal volume of each breath which varies based on gender, weight and work rate in a negative pressure respirator, or a flow rate supplied by a positive pressure respirator such as a Powered Air Purifying Respirator (PAPR) of the worker and a concentration of toxic material in the air all change how quickly or slowly a given toxic material will accumulate in the cartridge. Respirators may operate either under negative pressure or positive pressure. Powered air-purifying respirators (PAPRs) can be operated in a positive-pressure continuous flow mode utilizing filtered ambient air. Alternatively, Negative-Pressure Airflow Negative pressure respirators operate by the wearer drawing air into the facepiece via the negative pressure created by the user's inhalation. As described herein, the term “flow rate” is used to refer, in positive pressure embodiments, the blower flow rate and, in negative pressure embodiments, a user's inhalation rate.

Additionally, each of hundreds of toxic chemicals may be present in a particular environment, all with their own varying adsorption behavior. Because the adsorption rate for a filter can vary significantly based on so many parameters, it is difficult for manufacturers to provide a precise service life. Wood et al. describes equations for a simulation that can be completed for determining adsorption rate of a sorbent bed. (Estimating Service Lives of Organic Vapor Cartridges, Wood et al., American Industrial Hygiene Association Journal, J.55(1): 11-15 (1994); Estimating Service Lives of Organic Vapor Cartridges IIL A Single Vapor at All Humidities, Wood, Gerry O., Journal of Occupational and Environmental Hygiene, J1: 472-492; Estimating Service Lives of Organic Vapor Cartridges III: Multiple Vapors at All Humidities; Wood et al., Journal of Occupational and Environmental Hygiene, J4: 363-374). Currently many developed service life software programs are based on the Wood equations and may only have accuracy of around +/−50%. Employers want to efficiently use filter cartridges to reduce costs, but not at the risk of chemical breakthrough that could harm workers. An improved way to estimate a remaining capacity for a filter is desired.

The term “filter” and similar words such as “filter cartridge”, “filter canister”, “respirator filter”, “filter element”, and “Gas & Vapor filter” may all be used herein to refer to an article with sorbent substance packed or filled in a defined shape that is used to remove gas and vapor contaminants in air stream that passes through. The “filter cartridge” and “filter canister” may contain certain volume of sorbents as suggested in NIOSH “Guide to Industrial Respiratory Protection” by Dept of Health and Human Services v. 1987, but are not limited by those specified volume ranges. All above mentioned terms are considered used interchangeable hereinafter. All can be of different shapes and sizes.

The term “combination filter” refer to a “filter” or “filter cartridge” or “filter canister” or “respirator filter”, “filter element” or “gas and vapor (G&V) filter” that has particulate removal filter(s) incorporated for intended use of removing both gas and vapor contaminants and particulate contaminants (in air and/or gas).

The term “particulate filter” refers to a filter that only removes particulates (in air and/or gas).

The term “sorb” and similar words such as “sorbing”, “sorbed”, and “sorption” refer to the addition of a first substance (e.g. a gas such as hydrogen sulfide, sulfur dioxide, ammonia or vapor such as octane, toluene, benzene, cyclohexane, to a second substance (e.g. a porous sorbent such as activated carbon or porous polymeric material or both) by adsorbing, absorbing, or both. The first substance is sometimes referred to as a “sorbate”.

The term “sorbent” refers to a second substance that sorbs the first substance by adsorbing, absorbing, or both. The sorbent can interact with the first substance being sorbed by physisorption, chemisorption, or both. Sometimes the term “demand substance” may be used to refer to a substance capable of adsorbing gas and vapor. Suitable demand substances are described in U.S. Pat. No. 9,291,484 (assigned to 3M). Examples of sorbent materials include, for example, activated carbon, treated activated carbon, alumina, silica gel, hopcalite, molecular sieves, metal-organic frameworks, or a combination thereof.

The term “sorbent bed” refers to a volume of sorbent substance that is packed in a defined shape in a filter. The sorbent bed may have multiple sorbent materials layered or mixed. The bed may be formed with other non-sorbent materials such as fibers and/or binders. The bed can take on various geometric shapes. It may also be referred to “filter bed”.

The term “adsorption capacity” refers to the amount of adsorbate taken up or adsorbed by the adsorbent per unit mass (or volume) of the sorbent bed. The “maximum adsorption capacity” or “Total capacity” describes the amount of adsorbate on sorbent when all of the adsorption sites (micro, meso, and macropores) are filled with the adsorbate.

The term “service life” refers to the amount of time that sorbent bed in a filter adsorbs a given gas and vapor contaminant under certain (temperature and relative humidity) condition till either the contaminant concentration exiting or leaving the filter reaches a pre-set limit or after a pre-set time duration.

The term “residual life”, refers to the difference between service life and used service life for a given gas and vapor contaminant. Sometimes it is also referred to as “remaining capacity” or “residual capacity”, when comparing the used adsorption capacity to maximum adsorption capacity prior to filter reaching service life. The difference may be expressed in terms of time or percentage.

The term “and/or” means either or both. For example, “A and/or B” means only A, only B, or both A and B.

Systems and methods described herein refer to the use of computer-based models and/or computer-based simulators. Said models or simulators may be based on one or more algorithms, may incorporate machine learning, or otherwise may be used to model or simulate conditions. As described herein, in some instances, some parameters may be estimated while others are retrieved from available information—e.g. databases, sensor signals, etc. Said models or simulators may be executed by a processor that may be local to a device, on a remote datastore, in a cloud based datastore, or otherwise suitably accessible.

Previous methods to improve estimates of remaining filter service live have included linear models. Other solutions (such as the 3M 6001i gas and vapor cartridge) incorporate sensors into a respirator to detect chemical exposure at a certain point in the sorbent bed, or within the respirator itself. However, many such sensors typically only respond to a small fraction of the total hazards and may be expensive, or require space within the device or require battery life. A better solution for accurate, in-situ modeling or simulation of adsorption rates is needed to ensure that used filters are replaced before a worker is exposed to a harmful material. Systems and methods herein provide for more accurate simulation of filter loading, using sensor or other information retrieved in real-time to update a simulation as available.

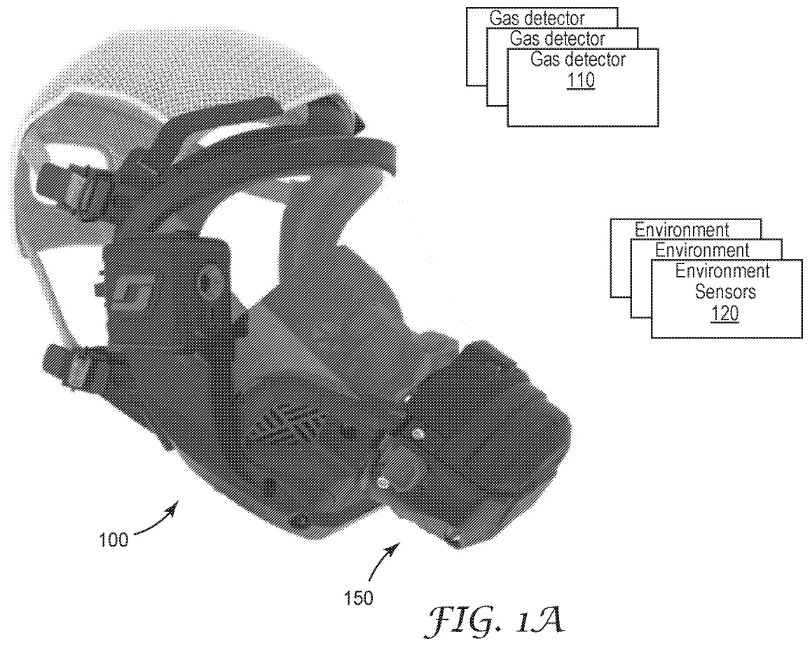

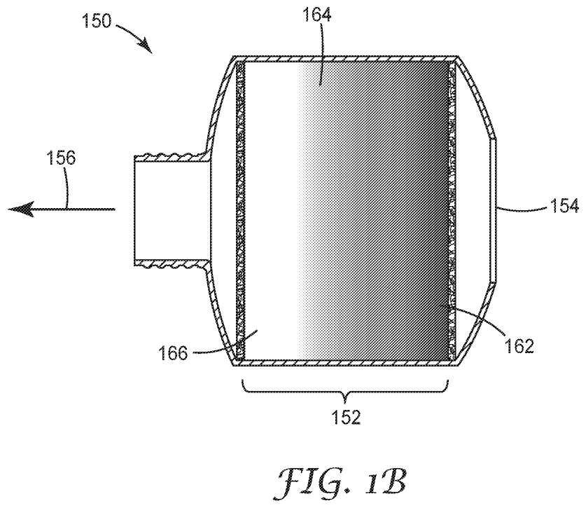

FIGS. 1A-1B illustrate a PPE device in which embodiments herein may be useful. FIG. 1A illustrates a respirator 100 with a filter cartridge 150 and a full-face shield. However, it is expressly contemplated that embodiments herein may be implemented with more than one and other filtering devices and other headgear. Additionally, more or less PPE may be present in some embodiments, such as communication devices integrated into, or separate from, PPE (shown as a respirator) 100; hearing protection integrated into, or separate from, respirator 100; eye and face protection integrated into, or separate from, respirator 100, helmet or other head protection integrated into, or separate from, respirator 100, etc. Additionally, a wearer of PPE 100 may also have other devices that are communicably coupled to respirator 100 or to a central hub, for example using a wireless network such as WiFi™, Bluetooth®, NFC, RFID, etc. or through a wired communication link. PPE 100 may optionally comprise a HUD (Heads Up Display) providing real-time visual update of the remaining filter capacity detection system data to the PPE wearer.

FIG. 1B illustrates a schematic of a cross-sectional view of a filter. Contaminated air is received through an air intake 154, where it passes through a sorbent bed 152. The sorbent bed is made of material(s) that is designed to adsorb contaminants from the ambient environment, such as, hazardous inorganic and organic gas and vapors. The filtered air exits as indicated by arrow 156, where it is breathed in by a wearer of PPE 100. Filter sorbent bed 152, as it is used, has a concentration profile of the hazardous gas or vapor as illustrated in FIG. 1B. As illustrated in FIG. 1B a concentration profile forms as filter bed 152 filters an air stream and contaminant gas or vapor is being adsorbed to the bed, with a fully loaded portion 162 at an air intake side of filter 150, and an unloaded portion 166 at a respirator coupling side of filter 150. As illustrated in FIG. 1B, at least a portion of sorbent bed 152 is partially loaded 164.

The leading edge of a concentration profile will reach the edge of adsorbent bed 152 before the entire length of adsorbent bed 152 is fully loaded. When the adsorbent bed 152 is partially loaded, a filter may no longer provides adequate protection, and the worker is exposed to the unsafe contaminant. The amount of acceptable breakthrough depend on the contaminant and exposure threshold levels. For example, filters may be considered useable, in some cases, up to 1%, 10% or even 50% breakthrough. However, up until a breakthrough threshold is reached, a filter is still useable. However, estimating how a concentration profile has progressed through bed 152, and when breakthrough will occur, is difficult as the concentration profile is dependent on a number of variables that change during a shift, including concentration of hazardous gas and vapor contaminants throughout an environment, temperature, flow rate (e.g. breathing rate of a wearer of PPE 100), relative humidity, and atmospheric pressure, to name a few. Depending on the environment of a worksite, an average usable time for a filter can vary wildly, from only a few hours, to a whole shift, to multiple shifts. For some worksites, these parameters may vary enough that workers in a first area have a significantly different expected service life for the same filter than a worker in a second area. The common practice of replacing air purifying filters after a certain period of time in service does not take those variations into account. A better method for estimating remaining capacity or residual service life is needed to assist in keeping all workers in an environment safe.

In some embodiments, the adsorption capacity of a filter 150 is estimated using an algorithm and a set of mathematical models with default parameter values. The algorithm may have analytical, numerical, empirical, or semiempirical adsorption models using algebraic equation, differential equation, or data regression for examples. A model for sorbent bed 152 can be created to simulate how the filter is being used based on known, and estimated, parameter values. For example, specifications of a particular filter can be known from a manufacturer. In some embodiments, a set of default parameter values are used for user and environmental estimates. However, in some embodiments, the model can receive sensor or other indicia of environmental or user information and replace default parameter values with known values. In some embodiments further still, the model is periodically updated to provide more accurate concentration profile estimates. Periodically, or continuously, updated parameter value information can be sought and the model updated. For example, as a temperature rises or falls during the day in an outdoor site, the simulation can be updated and concentration profile inside the filter more accurately estimated. The temperature information may come from a temperature sensor associated with PPE device 100, with another PPE device, with a sensor in a worksite, or may be retrieved from a weather service, or over the internet from a weather prediction website for the area. Similarly, flow rate for the filter may be estimated based on a known height, weight and gender of a wearer using OSHA generated estimated breath rate. Or an actual breathing rate can be used if available, for example based on breathing sounds captured by a microphone associated with PPE device 100 or another PPE device, or based on a heartrate obtained from a fitness device or other physiological monitoring device, or based on a sensor signal, e.g. detecting that a valve is open or closed. Additionally, flow rate for a positive pressure respirator such as a PAPR can be estimated by the blower setting, hood fit, and filter loading, battery usage, or be retrieved per manufacturer's claim.

As illustrated in FIG. 1A, the simulation model may be updated based on sensor signals within the worksite, such signals from concentration sensors 110, which provide indicia of concentration levels at different points within the worksite. Once determining) the location of device 100, an estimated concentration at the location of device 100 can be estimated from sensors 110. Similarly, environmental conditions can be obtained from environmental sensors 120 within a worksite. While FIG. 1A illustrates sensors 110 and 120 are within the worksite, it is also expressly contemplated that, in some embodiments, they are part of device 100, another PPE device, or another device communicably coupled to device 100.

While many forms of simulation models may be used, one example is a partial differential equation model that, as derived below, can be used to solve for the concentration profile of adsorbent bed 152.

The basic equation of mass balance for adsorbate in a fixed adsorption bed is:

$$( Accumulation in adsorbed phase ) + ( Accumulation in gas phase ) = ( Net flow in by convection ) + ( Net flow in by diffusion / dispersion ) \qquad Equation 1$$

For a fixed bed process with axial dispersion and no pore diffusion, we have the following sorbate material balance (Ding, F. 2020):

$${ρ}_{b} \frac{dq}{dt} + ε \frac{\partial c}{\partial t} = - v \frac{\partial c}{\partial z} + D \frac{{\partial }^{2} c}{\partial {z}^{2}} \qquad Equation 2$$

where where q is the sorbed phase concentration, c is the gas phase concentration, t is time, z is distance in the sorbent bed from the entrance, ρ_{b} is the packing density, and D is the apparent axial dispersion coefficient.

The axial dispersion coefficient, D, for a forced breakthrough bed operation and gas phase diffusion coefficient for a static bed.

The uploading rate is related to the concentrations via Linear Driving Force (LDF) approximation. One form is given according to the Ruthven linear driving force approximation, provided as Equation 3.

$$\frac{dq}{dt} = {k}_{R} ( {q}_{e} - q ) \qquad Equation 3$$

Where k_{R} is the LDF coefficient. Ding proposed a concentration LDF form as (Ding, F. 2020).

$${ρ}_{b} \frac{dq}{dt} = {k}_{D} ( c - {c}_{s} ) \qquad Equation 4$$

Where k_{D} is the surface diffusion coefficient for the chemical. Equation 4 is derived by Fick's diffusion model at the surface of the sorbent particle.

The boundary conditions are described below in Equation 5:

$$\{ \begin{matrix}c = {c}_{f} & Feed End \\ \frac{\partial c}{\partial z} = 0 & Effluent End\end{matrix} \qquad Equation 5$$

The governing or controlling partial differential equations are solved using numerical method to give out the simulation of the evolving process of the bed concentration profiles over time, and the results can be visualized to the user in substantially real-time, and the remaining capacity or a residual life can be estimated either through the computer algorithm or by the user. Remaining capacity or residual life is thus estimated using the current bed profiles as well as the current feed conditions. Based on concentration profile estimates, an end of service life warning can be issued when the remaining capacity or residual life is estimated to be below a preset threshold.

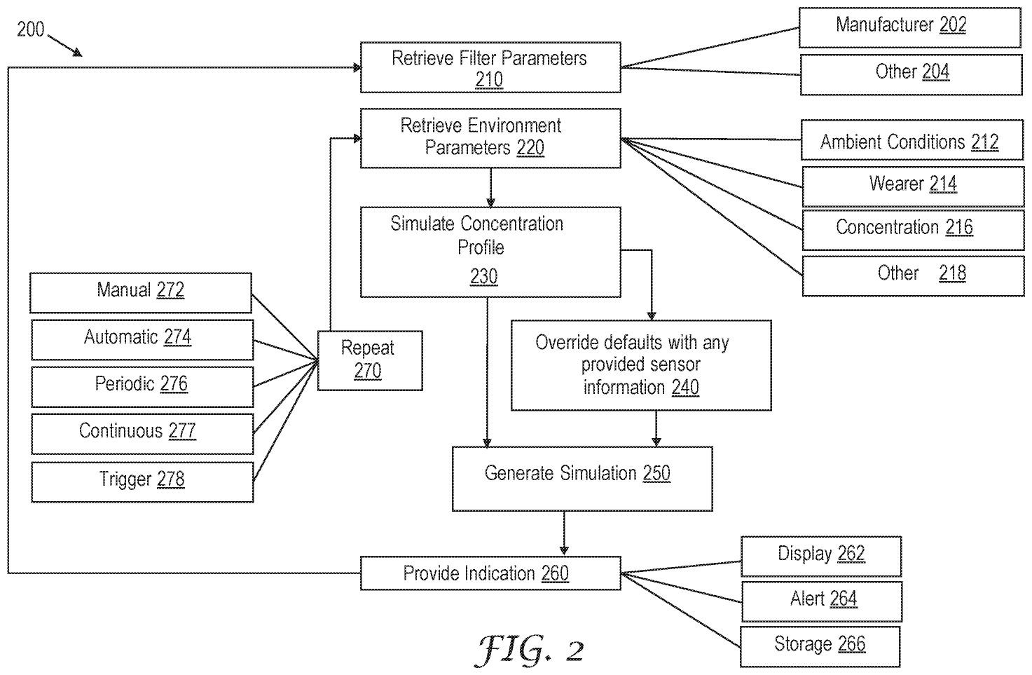

FIG. 2 illustrates a method of generating a concentration profile for a filter in accordance with embodiments herein. Method 200 may be implemented locally on a processing unit within a PPE device, such as a respirator or within a filter cartridge unit, or as part of other filter-containing device. Method 200 may also be implemented remotely from a respirator, for example on a separate device such as a mobile computing device (smart phone, tablet, laptop, etc.) associated with a wearer of the filter, or with another worker or supervisor in an environment. Method 200 may also be implemented on a computing device located remotely from a respirator.

A benefit of method 200, over other prior art methods of estimating or detecting a concentration profile or breakthrough, is that it may operate without a sensor within the filter cartridge unit, respirator mask, PPE, or environment. While a simulation result of method 200 may be made more accurate by providing real-time sensor data related to the environment, no sensor feedback is required.

In block 210, filter parameters are retrieved. For example, manufacturer-provided information 202 may be available, including bed parameters such as length, height, width, sorbent amount and type, configuration, etc. Filter information may be retrieved from a manufacturer database, or may be stored locally, for example in an onsite database, in a local storage media of a PPE device, or otherwise readily retrievable using wired, wireless or cloud-based network communications. Other information 204 may also be stored regarding the filter, such as a model number, a lot number, a date of manufacture, an expiration date, a presence of an optional particulate pre-filter, a timestamp related to when the filter was purchased, installed, a regulatory certification, etc.

In block 220, available environmental parameters are retrieved. Ambient conditions 212 may be located within a worksite, for example temperature, barometric pressure, relative humidity, or other sensor data. Ambient condition information 212 may also be retrieved using a wireless network, for example from a weather website, satellite information or another source.

Similarly, information about a wearer 214 of a specific filter may also be retrieved, if available. For example, breathing rate and tidal volume may be estimated based on known wearer information. If a particular wearer is identifiable, their height, weight and gender may be retrieved from a worker database and, in some embodiments, tidal volume is estimated. Similarly, based on work type and work rate, OSHA work rate estimates can be retrieved and used to calculate breathing rate based on worker information. In other embodiments, actual breath rate information may be retrievable, for example based on breath sounds, a flow rate sensor, a visual indication of valve open/closure, physiological harness, or another suitable indication.

Concentration information of hazardous gas and vapors 216 may also be retrieved, for example from worksite concentration sensors, or from other sources, such as gas detection sensors associated with a wearer, for example within a respirator or another PPE device. Other sensor information 218 may also be retrieved.

In block 230, a concentration profile is simulated based on available information. A default parameter set is initially used, for example an 8-hour shift in an environment with regular weather conditions—e.g., 70° F. at 9 AM with 20% relative humidity for the first hour, with the temperature escalating to 85° F. by 2 PM, while the relative humidity remains constant, and at a constant barometric pressure. The weather conditions may be preprogrammed based on historic weather information, climate data or another suitable method. A default concentration of the various containments, for example 20 ppm of toluene, may be set based on expected or historic concentration measurements. Similarly, any of weather information 212 or concentration information 216 may also be retrieved from peer devices, for example other PPE devices, or other sources. In other worksites, such as a factory setting, a number of fixed site detectors detect information, which is then shared either directly to devices or to a concentration profile simulator. Then, based on a detected location of a device containing a filter, a best estimate of concentration can be obtained by averaging nearby concentration signals or other estimation procedures. For example, in a distillation site, a worker generally has at least one device, PPE or otherwise, that can provide a GPS sensor signal indicative of a worker location. A concentration profile for the area immediately around the worker can then be estimated based on nearby sensor signals. Other environmental information 218 may also be retrieved.

In block 240, one or more default parameters are replaced with any actual, or estimated, parameter value information as described above. As described herein, one particular benefit of the embodiments of the present invention is the ability to simulate accurate concentration profiles without sensors on the filter or filter cartridge itself. In the case of a PAPR, this can extend PPE device battery life and reduces overall device complexity and cost, as power is not required for said sensors. In other cases, a battery would need to be added to the device to obtain measurements.

The set of default parameters may be generated, for example, based on historic site information. For example, even though a worker moves through an environment with different concentration levels, a default may be set that is an average of concentration levels, for example, or is a highest concentration level, which may provide a more conservative estimate of residual life left for a filter. Similarly, other default parameter values can be used, such as an average temperature and relative humidity based on building conditions (indoor) or climate/season (outdoor), etc.

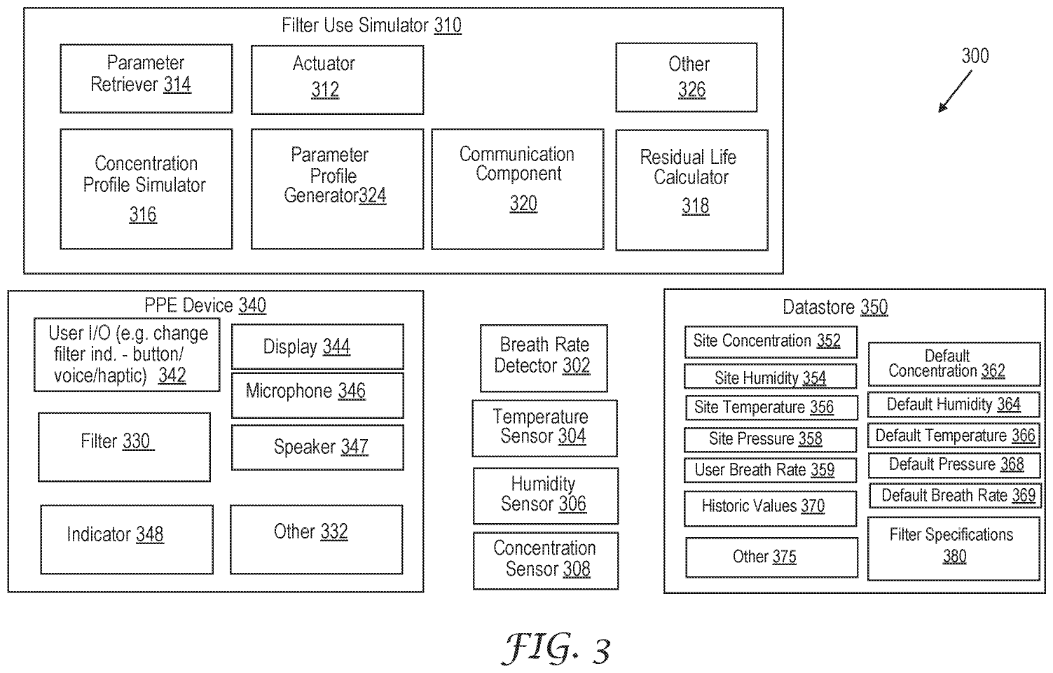

In block 240, in some embodiments, a concentration profile simulator may explicitly query a database, or communicably coupled sensors, for updated or available sensor signals. Alternatively, in other embodiments, parameter value information is provided to a concentration profile simulator as it is received, such that when a concentration profile simulator is actuated, provided parameter value information is already available. Other configurations of providing sensor signal information to a concentration profile simulator are explicitly contemplated herein. Additionally, as illustrated in FIG. 3, it is also explicitly contemplated that a concentration profile simulator operates with only default sensor information.

In block 250, a profile is simulated for the filter. The simulation will use an algorithm may have analytical, numerical, empirical, or semiempirical adsorption models using algebraic equation, differential equation, or data regression or another suitable method. For example, the differential equation set above may serve as the model to be solved.

The embodiments described herein are advantageous because the concentration profile in the filter bed can be simulated quickly, and updated at regular time intervals as new information is available. The integration algorithm requires that the step size be limited to within a few second such that the integration error is controlled within acceptable range. To respiratory protection applications, this fast speed of calculation provides nearly instant update of the evolving of the contaminant concentration inside the sorbent bed. In environments where concentration varies significantly within an environment, a constantly updated simulation, paired with stored historic simulation data, provides a good picture of how a concentration profile progresses through a filter bed.

In one embodiment, a partial differential equation solver algorithm provides profile information for a sorbent bed. In embodiments herein, the partial differential equation solver includes or is incorporated into an electronic device having a processor, memory and the algorithm that solves the simulation model.

In block 260, an indication of the simulation results is provided. The indication may be provided through a display as indicated in block 262, for example on a heads-up display of a PPE device, on a screen of a computing device such as a smart phone, smart watch, laptop, etc. The display may be updated as new information is available. The indication may also be provided as an alert, as indicated in block 264, for example provided to a worker or their supervisor or a safety officer. An alert may be provided visually, audibly, through haptic feedback or another method or combined methods. The alert may only be provided if a threshold is reached, such as an anticipated breakthrough time occurring within a specified time limit, or simulated contaminant concentration reaching a certain bed capacity, or contaminant concentration significantly above or below historical average. Other triggering events are also envisioned in some embodiments herein.

As indicated in block 266, the concentration profile indication may also be provided to a storage, such as a non-volatile memory associated with a computing device. Storage 266 may be local to a PPE device, local within a worksite, part of a second device associated with the same worker, part of a device associated with a supervisor or safety officer, stored in a storage accessible over a wireless or cloud-based network, or another suitable location.

The indication provided in block 260 may be an estimated capacity, a concentration bed profile or another suitable indication of adsorption progress within a filter adsorbent bed.

In block 270, method 200 repeats, at least in part. As illustrated in FIG. 2 in some embodiments method 200 progresses back to block 210. This may be helpful in embodiments where a filter replacement is detected, such that parameters relevant to the new filter are retrieved. However, it is also contemplated that, in many embodiments or for much of the time, method 200 repeats with the same filter parameters and proceeds from block 260 back to block 220, where available environmental parameters are retrieved, as discussed above.

Method 200 may repeat based on a manual indication from a user, as indicated in block 272. For example, a user may actuate a filter concentration profile simulation as part of a beginning of shift, end of break or other standard protocol where a worker is about to enter or leave a worksite. A manual indication may also be input by a safety officer or supervisor to a second device, at a location remote from the worker, and the second device may send a communication to the concentration profile simulator.

It is also contemplated that method 200 may initiate or repeat automatically as indicated in block 274, for example based on detection of a user wearing a device containing a filter, for example retrieved through a sensor such as a visual sensor, movement sensor, or other suitable indication.

Repeating, as indicated in block 276, is also contemplated to include repeating the steps of blocks 220, 230, 240, 250 and 260 periodically. The integration algorithm requires that the step size be limited to within a few second such that the integration error is controlled within acceptable range. To respiratory protection applications, this fast speed of calculation provides nearly instant update of the evolving of the contaminant concentration inside the sorbent bed. Alternatively, as indicated in block 277, method 200 may repeat substantially continuously, with little or no delay between simulation generation, in block 250, and retrieving updated environmental parameters, in block 220. It may be preferred to continuously search for new environmental parameters, particularly concentration signals relevant to a worker's current location so that no large contamination events go undetected. Similarly, as discussed above, because a worker may be mobile through an environment, they may pass through areas of high or low concentration quickly moving from one area to another within an environment. It is desired to capture such information to provide a more accurate simulation of a concentration profile for a filter.

However, in embodiments where no sensor information is available, method 200 may only be run when triggered, as indicated in block 278, for example at the start of a shift or when a user first turns on a PPE device containing a filter. However, if an indication is received that sensor information, or other new information is available, then block 270 may be triggered to cause a repeat of blocks 220, 230, 240, 250 and 260.

FIG. 3 illustrates a filter loading simulation system in accordance with embodiments herein. FIG. 3 illustrates an embodiment where a filter use simulator is independent of both a PPE device 340, datastore 350, and a plurality of sensors. However, it is expressly contemplated that other configurations are possible, for example where any of filter use simulator 310, respirator 340, datastore 350 and/or environmental sensors are integrated into a device. However, it is expressly contemplated that some embodiments herein include concentration profile simulation data being generated on a device remote from a filter, such as by an application stored on a separate computing device like a cellphone, laptop or other computer-enabled device.

Currently, manufacturers provide a single replacement schedule based on given customer conditions. However, this is often just a best estimate of a number of hours that a filter can be used. The end-user is then responsible for counting the number of hours used, and to change the filter out when its useful life is expired. This requires a user to log hours where a filter is exposed to the given customer conditions. But if a filter is accidentally left in an area where it may be exposed to toxic or hazardous chemicals, the concentration profile may progress towards breakthrough even though a user is not wearing it. Similarly, even if left in an area without exposure to toxic or hazardous chemicals, migration may still occur. Capturing such information, in addition to unexpected concentration dips or surges, is crucial for providing more accurate filter concentration profile information. In some embodiments, a “running clock” is used so that estimates are based on actual exposure time for contaminants known to easily migrate.

Traditional methods attempting to simulate concentration profiles of a filter rely on constant site and worker activity conditions and often use an algebraic model to simulate. A system is desired that can track varying conditions and more accurately predict concentration profiles, for example by solving a differential equation model, which may be more accurate than algebraic models. Systems and methods described herein enable better estimates of concentration profiles based on changing environmental or worksite conditions. Based on updated environmental and worksite conditions, concentration profiles can be repeatedly simulated and updated, providing a simulation that is closer to the real concentration profile present in a filter. Embodiments herein are able to provide better simulation data without requiring a chemical sensor within a filter cartridge or a PPE device, reducing cost and device complexity while providing more accurate results.

Filter use simulator 310 includes a parameter retriever 314 that retrieves parameter value information. In the embodiment illustrated in FIG. 3, parameter retriever may communicate with sensors 302-308 directly, or may retrieve parameter value information from datastore 350. Filter use simulator 310 also includes a concentration profile simulator 316 that simulates a concentration profile for a filter 330 within a PPE device 340. Concentration profile simulator 316 simulates a concentration profile based on retrieved parameter values, default parameter values, or a set of mixed parameter values for an environment. Concentration profile simulator may generate a simulation based on a models that may be algebraic, regression or partial differential equation An actuator 312 causes parameter retriever 314 to retrieve updated parameters, and concentration profile simulator 316 to conduct a simulation based on available parameters. Actuator may initiate retrieval and simulation based on a number of triggers. In some embodiments, actuator causes retrieval and simulation continuously, or substantially continuously such that a new simulation round is initiated after the previous one ends, with little or no dwell time in between the end of one simulation and the start of the next simulation. Actuator 312 may also cause retrieval and simulation periodically, in some embodiments, with a set or variable dwell time between simulations. Actuator 312 may also, or instead, cause retrieval and simulation based on a detected trigger, such as movement of worker from a first point to a second point, detected change in one or more parameters greater than a threshold change, or another trigger. Actuator 312 may also cause retrieval and simulation based on received input, for example using a user input/output mechanism 342 on a PPE device 340, based on a command from a supervisor device, or another command received using communication component 320. Communication component 320 may operate using wired or wireless protocols.

Based on a concentration profile simulation from simulator 316, a remaining filter capacity calculator 318 may calculate an estimate of an amount of use time remaining for a filter based on current or projected conditions.

Filter use simulator 310 may also have a parameter profile generator 324 that generates a profile of a parameter based on historic sensor data. For example, worksite temperature data 356 may be stored in datastore 350. A graphical or other representation of parameter values over time may be generated by parameter profile generator 324 for communication to another device, for example PPE device 340 or another device, for display or analysis.

Filter use simulator 310 may have additional features 326 as well. For example, filter use simulator 310 may include a feedback loop, which may be useful where noisy, inaccurate or insufficient data is provided. Filter use simulator may also include a breakthrough detector, which may be used to improve future simulation accuracy. For example, a premature, or late, breakthrough may indicate that sensor readings were inaccurate, default readings are too high or too low, or that the concentration of the contaminant was inaccurate. This may provide information for EHS personnel to update default values or check to ensure that sensors are working accurately.

PPE device 340 may include a user I/O device 342, such as a button, touchscreen, switch or other input receiving device. PPE device 340 may also have a display 344, for example either built into a device, provided as an augmented reality overlay on a face shield, googles, etc. PPE device 340 may also include a microphone 346, which may serve to receive verbal commands from a user or as a form of communication for a wearer of PPE device 340. PPE device 340 may also have one or more speakers 347 that can provide audible feedback for a wearer of PPE device 340.

PPE device may also have a filter 330 that has a number of parameters associated therewith including bed depth, carbon (or other adsorbent) volume, packing density, molecular weights, vapor pressure models, exposure limit and IDLH concentration, adsorption equilibrium, etc. The parameter values for a given filter 330 may be stored as filter specifications 380 in datastore 350. PPE device may also, in some embodiments, have an indicator that can provide some alert information. Indicator may be a light that turns on, off or a different color based on the amount of service life estimated for filter 330. Indicator 348 may also be an audible alert provided through speaker 347 or another speaker. Indicator 348 may also be a haptic feedback generator. PPE device 340 may also have other functionality 332.

Within an environment there may be fixed or mobile sensors that can capture environmental information. Such sensors, if mobile, may be carried by the worker such as gas detection or maybe affixed to a PPE worn by the worker. For example, a temperature sensor 304 may capture temperature information for a worksite, while a humidity sensor 306 may capture relative humidity information. A gas concentration sensor 308 may provide an indication of gas concentration near the sensor. Additionally, a flow rate, or breathing rate detector 302 may be present. These sensors may be integrated into a PPE device, for example a device containing filter 330 or in communication with device 340.

The breath rate of a wearer of PPE device 340 can be determined in one of any suitable ways. For example, if an identity of a wearer of PPE device 340 is known or discoverable, a breathing rate can be estimated based on a height, weight and gender of an individual using OSHA lookup tables in combination with the work rate. Or, a user can get a better estimate using a microphone 346, or physiological monitoring harness such as the Bioharness will provide breathing rate associated with either PPE device 340 or with another PPE device.

Datastore 350 may be incorporated into PPE device 340, in some embodiments, into a device that also includes filter user simulator 310, or into a separate device altogether. Datastore 350 may be accessed through a wired or wireless communication protocol or may be accessed using cloud-computing. Datastore 350 may include current site parameter value information for a given worksite, including concentration 352, relative humidity 354, temperature 356, atmospheric pressure 358, and user breathing rate or blower flow rate 359.

Datastore 350 may also include default site parameter information to be used by concentration profile simulator 316 if site-specific data is unavailable, such as default concentration 362, relative humidity 364, temperature 366, pressure 368, and user breathing rate or blower rate369. Filter specifications 380 for filter 330 may also be stored in datastore 350. Datastore 350 may include multiple filter specifications 380, if multiple types of filters are in use for a given worksite. Datastore 350 may also include historical values 370 obtained by simulation or by in-device sensors. Other information 375 may also be stored in datastore.

In some embodiments, concentration profile simulator solves a set of control equations numerically with time and space to provide a real-time estimate of concentration profiles along a bed. Remaining filter capacity may then, in some embodiments, be estimated using current bed profiles and the current feed conditions. An end-of-service life warning may be issued, for example using indicator 348, display 344, and/or speaker 347, when the remaining capacity is below a preset threshold based on current estimates. For example, the preset threshold may be less than 30 minutes remaining, less than 1 hour remaining, or another suitable threshold. The threshold may vary based on the current conditions, for example with a wider margin if the current concentration is higher, in order to better ensure that breakthrough does not occur before the filter is replaced.

Remaining capacity may be estimated using either a Concentration Front Method or a Loading Front Method. In concentration front method, a Remaining Capacity is calculated as the clean fraction of bed space at the front where one or more concentrations of the target contaminants exceeds the designated exposure limit. In the Loading Front Method, the Remaining capacity is calculated as the Clean Fraction of Bed Space (CFBS) at the front where the total loadings of contaminant exceeds a certain criteria. The loading criteria can either be an arbitrarily assigned (e.g., 1% of the maximum loading), or be estimated from the adsorption equilibrium as the loading value in equilibrium with the exposure limit.

The Remaining Capacity is estimated as either the Remaining Capacity Percentage (RCP), or Remaining Capacity Time (RLT), using the following formulae:

$$RCP = CFBS \times 100 \% \qquad Equation 6$$

$$RLT = \frac{CFBS}{CFBS - CFBS 0} \times t \qquad Equation 7$$

Here CFBS0 is the CFBS value at the beginning of the operation (e.g. after being operated for a few minutes).

It should be noted that the Residual Life (remaining capacity time) is estimated based on the previous use experience and is subject to change if the filter sees significantly different site conditions from the previous or is used differently by users with different flow rate, breathing rate, or blower rate. Thus, it is recommended that the Residual Life be updated frequently and be used as a reference only.

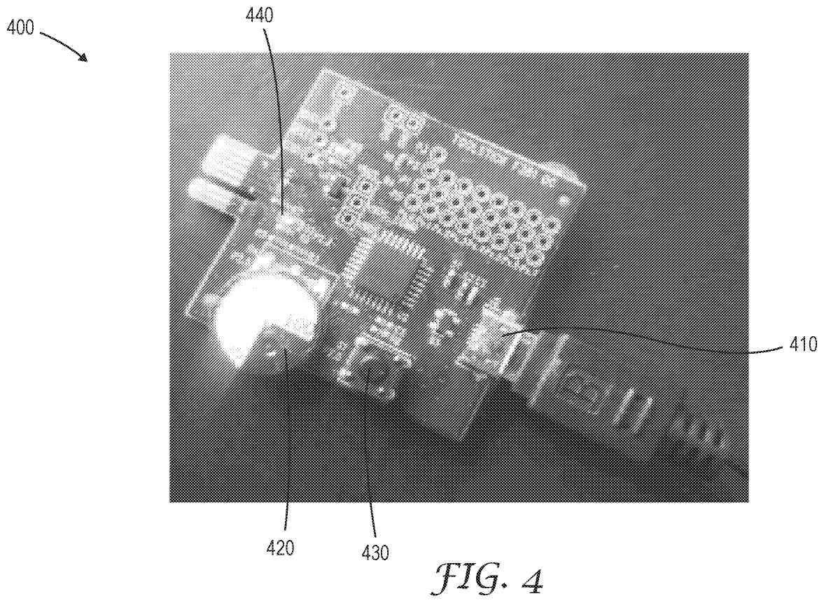

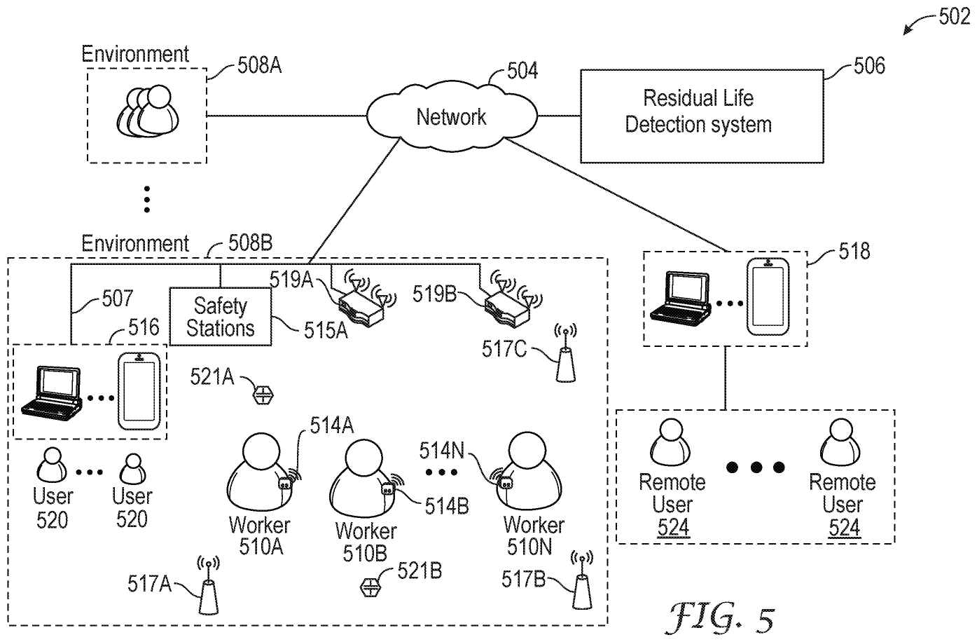

FIG. 4 illustrates a mobile simulation device in one embodiment of the present invention. FIG. 4 illustrates a mobile simulation computing device 400 that may simulate concentration profiles for a filter bed. In some embodiments, device 400 is coupled to a device with a display to provide a visual representation of a current concentration profile. As illustrated in FIG. 4, device 400 includes a connection 410 which may allow for wired communication between device 400 and a datastore with parameter value information. However, it is expressly contemplated that, in other embodiments, wireless communication is possible. Device 400 also includes an LED indicator 440 that may turn on when an estimated residual life or remaining capacity drops below a threshold. However, while FIG. 4 illustrates an embodiment with a visual indicator for residual life remaining, it is expressly contemplated that other methods of providing residual life or remaining capacity indications are possible.

Device 400 may also have memory to store simulation parameters received using wired communication 410. A thumbwheel 420 may be present to manual adjust a flow rate through a filter, as illustrated in FIG. 4. Based on a thumbwheel setting, a breathing rate from the worker may be inferred. However, as discussed herein, other methods of estimating flow rates are expressly contemplated. Additionally, a reset 430 is illustrated in FIG. 4, which may be actuated by a worker when a filter is replaced to restart the simulation and historic parameter storage over for a new filter. However, in other embodiments a reset may be automatically done by device 400, for example based on a signal received from a PPE device, which may detect that a filter has been changed.

FIG. 5 illustrates a worksite in which embodiments of the present invention may be useful. FIG. 5 is a block diagram illustrating an example network environment 502 for a worksite 508A or 508B. The worksite environments 508A and 508B may have one or more workers 510A-510N, each of which may need to interact with equipment or environments that require the use of personal protective equipment such as glasses, hard hats, fall protection equipment, respirators, gloves, etc. Workers 510A-510N may have a range of experience with a given worksite, with some knowing and complying with rules concerning personal protective equipment, and others who do not know, are still in training, or actively not complying with personal protective equipment requirements.

Environments 502 includes a remaining filter capacity detection system 506 for detecting and managing compliance with filter replacement requirements. FIG. 5 illustrates an embodiment where a central remaining filter capacity detection system 506 is in communication with workers 510A-510N, for example using displays within environment 508B, communicatively coupled PPE or other devices, such as cellular phones, Land Mobile Radios, etc. However, this is by illustration only. While it may be useful for large sites to have one central system that calculates and monitors remaining filter capacity for a number of respirators, systems and methods herein can also be implemented in other configurations, as described with regard to later Figures.

System 506 may be connected, through network 504, to one or more devices or displays 516 within an environment, or devices or displays 518, remote from an environment. System 506 may provide alerts to workers 510A-510N when a filter is estimated to be nearing the end of its service life. System 506 may also be integrated into entry protocols for different areas within an environment such that positional information of each worker 510A-510N, and associated environmental information regarding a known position, is known.

As shown in the example of FIG. 5, a computing device within of a plurality of physical environments 508A, 508B (collectively, environments 508) electronically communicate with system 506 via one or more computer networks 504. Each of physical environments 508A and 508B represents a physical environment, such as a work environment, in which one or more individuals, such as workers 510, utilize personal protection equipment while engaging in tasks or activities within the respective environment. A computing device may also communicate with one or more environmental sensors within environment 508B. For example, contaminant concentration sensors may be distributed at fixed points throughout an area so that contaminant concentrations are retrievable for each of the fixed points. Remaining filter capacity detection system 506 may, based on the known contaminant concentrations, replace a default concentration with a known or estimated contaminant concentration. For example, if a user is halfway between Point 1 and Point 2, an estimated contaminant concentration that averages the concentrations at Point 1 and Point 2 may be used. Other estimation methods may also be used, such as logarithmic estimations, fixed concentration estimates, etc. In another example, if a user goes from environment 508A to 508B and back forth, the measured and/or estimated contaminant concentrations reflecting each environment's condition, coupled with the actual filter use time and breathing rate or flow rate in each environment, can be used for Residual Life Detection system 506.

In this example, environment 508A is shown as generally as having workers 510, while environment 508B is shown in expanded form to provide a more detailed example. In the example of FIG. 5, a plurality of workers 510A-510N may be wearing a variety of different PPE, such as earmuff hearing protectors, in-ear hearing protectors, hard hats, gloves, glasses, goggles, masks, respirators, hairnets, scrubs, or any other suitable personal protective equipment.

In some embodiments herein, an article of PPE may include one or more of embedded sensors, communication components, monitoring devices and processing electronics. In addition, each article of PPE may include one or more output devices for outputting data that is indicative of operation of the PPE and/or generating and outputting communications to the respective worker 510. For example, PPE may include one or more devices to generate audible feedback (e.g., one or more speakers or bone conduction transducers), visual feedback (e.g., one or more displays or display types, heads up display (HUD) in a virtual reality or augmented reality (collectively known as XR) device such as a look through or look-at in-mask display built into a PPE or coupled to a PPE device, light emitting diodes (LEDs) or the like), or tactile feedback (e.g., a device that vibrates or provides other haptic feedback). Examples of in-mask displays are illustrated in U.S. Pat. No. 10,864,392, issued on Dec. 15, 2020, incorporated herein by reference.

In embodiments herein, workers 510A-510N may require a respirator with a filter in at least some areas of environment 508A. However, workers 510A-510N may also wear other PPE, which may be communicably coupled to a respirator and/or system 506. As described herein, while system 506 may provided simulated concentration profile estimates for filters associated with each of workers 510A-510N, said estimates can be more accurate with additional sensor information. For example, a hearing protection unit may have a microphone that can be used to get an accurate breath rate of a wearer. Similarly, full and half respirators, as well as any other PPE devices with communications (e.g. microphone and/or speaker) built in or communicably coupled. Alternatively, a harness, such as fall protection harness, may provide respiration rate of the worker, or any PPE worn by the worker may be equipped with a motion sensor to provide work rate of the wearer. As described herein, other PPE or devices associated with a worker, such as a smart phone, Land Mobile Radio, smart watch, or other communicably coupled device, may have internal or external sensors that can provide useful information for providing more accurate concentration profiles for filters associated with workers 510A-510N.

Similarly, environment 508B may also have a number of fixed or mobile sensors 521A, 521B. Sensors 521A and 521B may be temperature sensors, pressure sensors, relative humidity sensors, gas or vapor concentration detectors or another environmental sensor. If sensors are mobile they may be carried by worker 510 or attached to a PPE worn by worker 510.

In some examples, each of environments 508 include computing facilities, such as displays 516, or through associated PPEs, by which workers 510 can interact with system 506. For example, an alert can be presented on display 516 if worker 510B needs to replace a filter. For examples, environments 508 may be configured with wireless technology, such as 802.11 wireless networks, 802.15 ZigBee networks, LoRa, Ultra-Wide Band (UWB), LTE, and the like. In the example of FIG. 5, environment 508B includes a local network 507 that provides a packet-based transport medium for communicating with system 506 via network 504. In addition, environment 508B includes a plurality of wireless access points 519A, 519B that may be geographically distributed throughout the environment to provide support for wireless communications throughout the work environment.

As shown in the example of FIG. 5, an environment, such as environment 508B, may also include one or more wireless-enabled beacons, such as beacons 517A-517C, that provide accurate location information within the work environment. For example, beacons 517A-517C may be GPS-enabled such that a controller within the respective beacon may be able to precisely determine the position of the respective beacon. Alternatively, beacons 517A-517C may include a pre-programmed identifier that is associated in PPE compliance system 506 with a particular location. Based on wireless communications with one or more of beacons 517, or data hub 514 worn by a worker 510 is configured to determine the location of the worker within work environment 508B. In this way, sensor information provided to system 506 may be stamped with positional information. This may be helpful to estimate parameter values for a worker 510A moving throughout environment 508B. For example, if concentration of a hazardous material is high at 521B and low at 521A, an estimated concentration is likely higher for a worker closer to 521B than for a worker closer to 521A. For a worker moving from 521B to 521A, an estimated concentration that the worker is exposed to can be calculated, and provided to system 506, which may calculate a more accurate concentration profile for a filter associated with the worker than would be available without the concentration estimates.

In some implementations, an environment, such as environment 508B, may also include one or more safety stations 515 distributed throughout the environment to provide viewing stations for accessing calculations from system 506, or to obtain a replacement filter. Safety stations 515 may allow one of workers 510 to check out articles of PPE and/or other safety equipment, verify that safety equipment is appropriate for a particular one of environments 508, and/or exchange data. For example, safety stations 515 may transmit alert rules, software updates, or firmware updates to articles of PPE or other equipment.

In addition, each of environments 508 include computing facilities that provide an operating environment for end-user computing devices 516 for interacting with PPE compliance system 506 via network 504. For example, each of environments 508 typically includes one or more safety managers or supervisors, represented by users 520 or remote users 524, are responsible for overseeing safety compliance within the environment. In general, each user 520 or 524 interacts with computing devices 516, 518 to access system 506. For example, the end-user computing devices 516, 518 may be laptops, desktop computers, mobile devices such as tablets or so-called smart cellular phones.

Users 520, 524 may interact with system 506 to control and actively manage many aspects of safely equipment utilized by workers' 510, such as accessing and viewing environmental parameter history, workers' 510 history, such as filter replacement history, or other records, analytics and reporting.

System 506 may be configured to actively monitor sensors 521, workers 510A-510N and other users 520 within an environment 508 for updated information that could affect filter concentration profiles. For example, system 506 may receive an indication that an environmental temperature has risen, or that relative humidity has dropped, or that a worker's breath rate has increased.

System 506 may further trigger an alert if an estimated concentration threshold passes a threshold, or an estimated service life end is near. The alert may be sent to worker 510, either through a communication feature of a PPE, a separate communication device, or through a public address system within the environment. The alert may also be sent to a supervisor or safety officer associated with the environment 508 as well. Alerts may also be tracked and stored within a database, as described herein.

Techniques and components of this disclosure may improve the safety of workers within an environment by providing more accurate estimates of adsorption rates for each filter within the environment. Additionally, systems and methods herein can help workers within an environment look out for each other by seeing alerts concerning filter replacement needs.

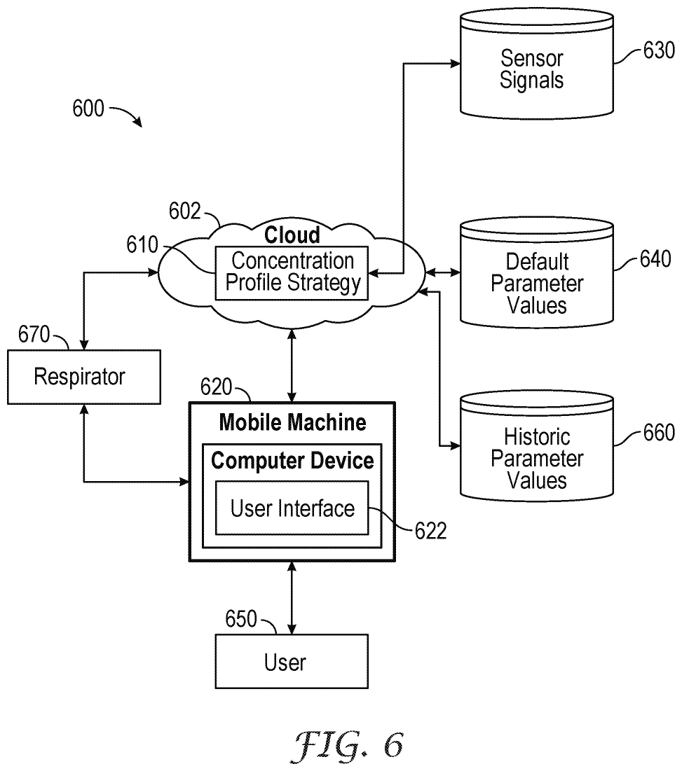

FIG. 6 illustrates a concentration profile simulation system architecture. Architecture 600 illustrates one embodiment of an implementation of concentration profile simulation system 610. As an example, architecture 600 can provide computation, software, data access, and storage services that do not require end-user knowledge of the physical location or configuration of the system that delivers the services. In various embodiments, remote servers can deliver the services over a wide area network, such as the internet, using appropriate protocols. For instance, remote servers can deliver applications over a wide area network and they can be accessed through a web browser or any other computing component. Software or components shown or described in FIGS. 1-5 as well as the corresponding data, can be stored on servers at a remote location. The computing resources in a remote server environment can be consolidated at a remote data center location or they can be dispersed. Remote server infrastructures can deliver services through shared data centers, even though they appear as a single point of access for the user. Thus, the components and functions described herein can be provided from a remote server at a remote location using a remote server architecture. Alternatively, they can be provided by a conventional server, installed on client devices directly, or in other ways.

In the example shown in FIG. 6, some items are similar to those shown in earlier figures. FIG. 6 specifically shows that a PPE evaluation system 610 can be located at a remote server location 602. Therefore, computing device 620 accesses those systems through remote server location 602. User 650 can use computing device 620 to access user interfaces 622 as well. For example, a user 650 may be a user wanting to check a fit of their respiratory protection device while sitting in a parking lot, and interacting with an application on the user interface 1022 of their smartphone 620, or laptop 620, or other computing device 620.

FIG. 6 shows that it is also contemplated that some elements of systems described herein are disposed at remote server location 1002 while others are not. By way of example, data stores 630, 640 and/or 660 can be disposed at a location separate from location 602 and accessed through the remote server at location 602. Regardless of where they are located, they can be accessed directly by computing device 620, through a network (either a wide area network or a local area network), hosted at a remote site by a service, provided as a service, or accessed by a connection service that resides in a remote location. Also, the data can be stored in substantially any location and intermittently accessed by, or forwarded to, interested parties. For instance, physical carriers can be used instead of, or in addition to, electromagnetic wave carriers. This may allow a user 650 to interact with system 610 through their computing device 620, to initiate a seal check process.

It will also be noted that the elements of systems described herein, or portions of them, can be disposed on a wide variety of different devices. Some of those devices include servers, desktop computers, laptop computers, imbedded computer, industrial controllers, tablet computers, or other mobile devices, such as palm top computers, cell phones, smart phones, multimedia players, personal digital assistants, etc.

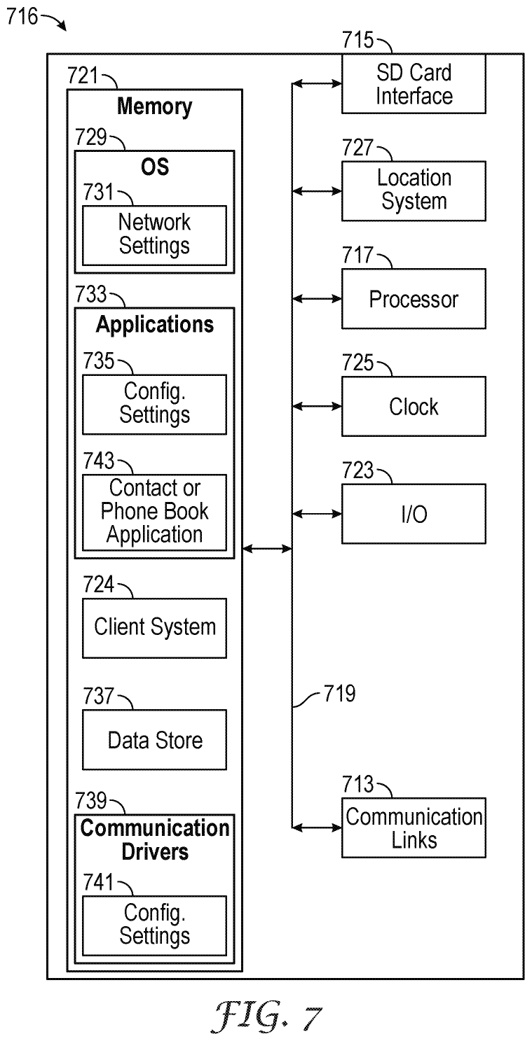

FIGS. 7-9 illustrate example devices that can be used in the embodiments shown in previous Figures. FIG. 7 illustrates an example mobile device that can be used in the embodiments shown in previous Figures. FIG. 7 is a simplified block diagram of one illustrative example of a handheld or mobile computing device that can be used as either a worker's device or a supervisor/safety officer device, for example, in which the present system (or parts of it) can be deployed. For instance, a mobile device can be deployed in the operator compartment of computing device for use in generating, processing, or displaying the data.

FIG. 7 provides a general block diagram of the components of a mobile cellular device 716 that can run some components shown and described herein. Mobile cellular device 716 interacts with them or runs some and interacts with some. In the device 716, a communications link 713 is provided that allows the handheld device to communicate with other computing devices and under some embodiments provides a channel for receiving information automatically, such as by scanning. Examples of communications link 713 include allowing communication though one or more communication protocols, such as wireless services used to provide cellular access to a network, as well as protocols that provide local wireless connections to networks.

In other examples, applications can be received on a removable Secure Digital (SD) card that is connected to an interface 715. Interface 715 and communication links 713 communicate with a processor 717 (which can also embody a processor) along a bus 719 that is also connected to memory 721 and input/output (I/O) components 723, as well as clock 725 and location system 727.

I/O components 723, in one embodiment, are provided to facilitate input and output operations and the device 716 can include input components such as buttons, touch sensors, optical sensors, microphones, touch screens, proximity sensors, accelerometers, orientation sensors and output components such as a display device, a speaker, and or a printer port. Other I/O components 723 can be used as well.

Clock 725 illustratively comprises a real time clock component that outputs a time and date. It can also provide timing functions for processor 717.

Illustratively, location system 727 includes a component that outputs a current geographical location of device 716. This can include, for instance, a global positioning system (GPS) receiver, a LORAN system, a dead reckoning system, a cellular triangulation system, or other positioning system. It can also include, for example, mapping software or navigation software that generates desired maps, navigation routes and other geographic functions.

Memory 721 stores operating system 729, network settings 731, applications 733, application configuration settings 735, data store 737, communication drivers 739, and communication configuration settings 741. Memory 721 can include all types of tangible volatile and non-volatile computer-readable memory devices. It can also include computer storage media (described below). Memory 721 stores computer readable instructions that, when executed by processor 717, cause the processor to perform computer-implemented steps or functions according to the instructions. Processor 717 can be activated by other components to facilitate their functionality as well. It is expressly contemplated that, while a physical memory store 721 is illustrated as part of a device, that cloud computing options, where some data and/or processing is done using a remote service, are available.

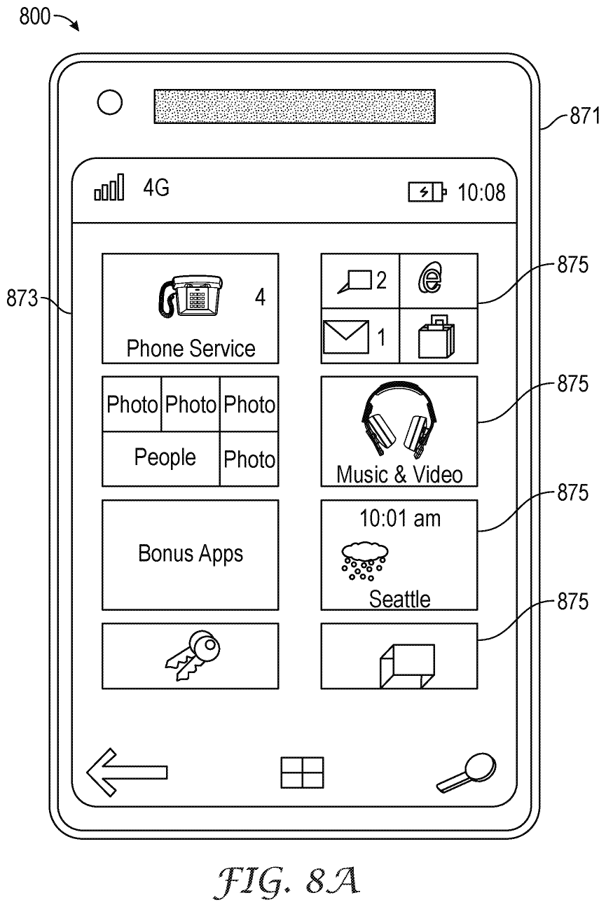

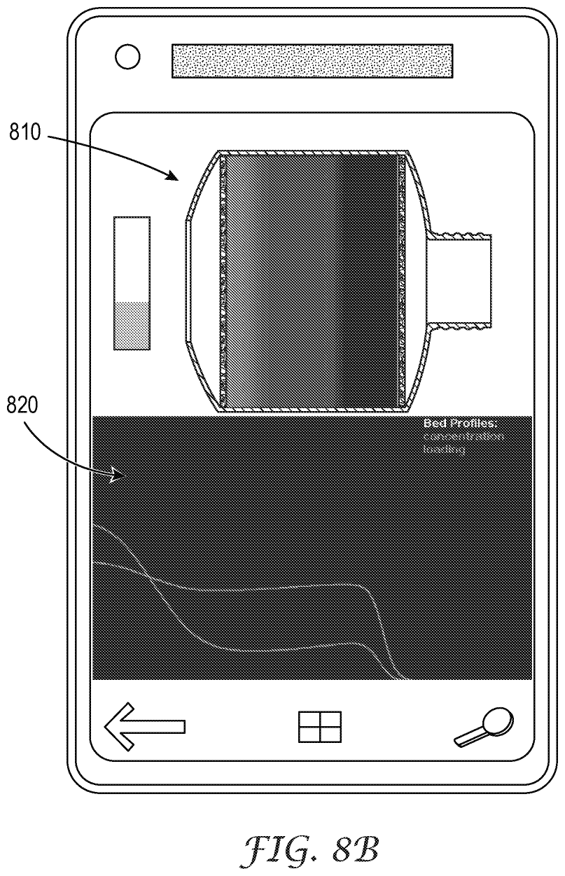

FIG. 8A shows that the device can also be a smart phone 871. Smart phone 871 has a touch sensitive display 873 that displays icons or tiles or other user input mechanisms 875. Mechanisms 875 can be used by a user to run applications, make calls, perform data transfer operations, etc. In general, smart phone 871 is built on a mobile operating system and offers more advanced computing capability and connectivity than a feature phone. Note that other forms of the devices are possible.

FIG. 8B illustrates an example user interface display that may be presented on a computer device in accordance with embodiments herein. However, while FIG. 8B illustrates an embodiment where a device 800 is a smart phone 871, it is expressly contemplated that either or both of displays 810 and 820 may be presented on another comping device, on a heads up display of a PPE device, or on a display within an environment, at a safety center for example. Display 810 illustrates a filter with a concentration profile illustrating the amount of the filter that is saturated and partially saturated. Display 810 may include an estimated amount of filter capacity remaining, in some embodiments.

Display 820 illustrates a profile view of parameters, generated by plotting parameter values collected at a number of times. For example, concentration and loading may be displayed, as illustrated in FIG. 8B, however other parameters may also be displayed, such as temperature, pressure, breath rate, etc.

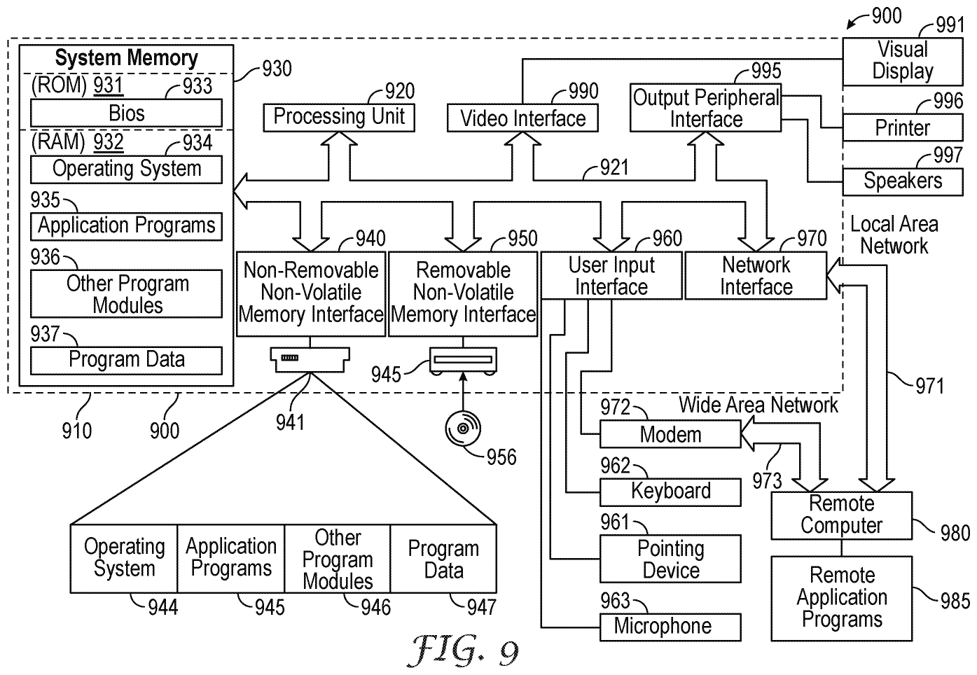

FIG. 9 is one example of a computing environment in which elements of systems and methods described herein, or parts of them (for example), can be deployed. With reference to FIG. 9, an example system for implementing some embodiments includes a general-purpose computing device in the form of a computer 910. Components of computer 910 may include, but are not limited to, a processing unit 920 (which can comprise a processor), a system memory 930, and a system bus 921 that couples various system components including the system memory to the processing unit 920. The system bus 921 may be any of several types of bus structures including a memory bus or memory controller, a peripheral bus, and a local bus using any of a variety of bus architectures. Memory and programs described with respect to systems and methods described herein can be deployed in corresponding portions of FIG. 9.

Computer 910 typically includes a variety of computer readable media. Computer readable media can be any available media that can be accessed by computer 910 and includes both volatile/nonvolatile media and removable/non-removable media. By way of example, and not limitation, computer readable media may comprise computer storage media and communication media. Computer storage media is different from, and does not include, a modulated data signal or carrier wave. It includes hardware storage media including both volatile/nonvolatile and removable/non-removable media implemented in any method or technology for storage of information such as computer readable instructions, data structures, program modules or other data. Computer storage media includes, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can be accessed by computer 910. Communication media may embody computer readable instructions, data structures, program modules or other data in a transport mechanism and includes any information delivery media. The term “modulated data signal” means a signal that has one or more of its characteristics set or changed in such a manner as to encode information in the signal.

The system memory 930 includes computer storage media in the form of volatile and/or nonvolatile memory such as read only memory (ROM) 931 and random-access memory (RAM) 932. A basic input/output system 833 (BIOS) containing the basic routines that help to transfer information between elements within computer 910, such as during start-up, is typically stored in ROM 831. RAM 832 typically contains data and/or program modules that are immediately accessible to and/or presently being operated on by processing unit 920. By way of example, and not limitation, FIG. 9 illustrates operating system 934, application programs 935, other program modules 936, and program data 937.

The computer 910 may also include other removable/non-removable and volatile/nonvolatile computer storage media. By way of example only, FIG. 9 illustrates a hard disk drive 941 that reads from or writes to non-removable, nonvolatile magnetic media, nonvolatile magnetic disk 952, an optical disk drive 955, and nonvolatile optical disk 956. The hard disk drive 941 is typically connected to the system bus 921 through a non-removable memory interface such as interface 940, and optical disk drive 955 are typically connected to the system bus 921 by a removable memory interface, such as interface 950.

Alternatively, or in addition, the functionality described herein can be performed, at least in part, by one or more hardware logic components. For example, and without limitation, illustrative types of hardware logic components that can be used include Field-programmable Gate Arrays (FPGAs), Application-specific Integrated Circuits (e.g., ASICs), Application-specific Standard Products (e.g., ASSPs), System-on-a-chip systems (SOCs), Complex Programmable Logic Devices (CPLDs), etc.

The drives and their associated computer storage media discussed above and illustrated in FIG. 9, provide storage of computer readable instructions, data structures, program modules and other data for the computer 910. In FIG. 9, for example, hard disk drive 941 is illustrated as storing operating system 944, application programs 945, other program modules 946, and program data 947. Note that these components can either be the same as or different from operating system 934, application programs 935, other program modules 936, and program data 937.

A user may enter commands and information into the computer 910 through input devices such as a keyboard 962, a microphone 963, and a pointing device 961, such as a mouse, trackball or touch pad. Other input devices (not shown) may include a joystick, game pad, satellite receiver, scanner, or the like. These and other input devices are often connected to the processing unit 920 through a user input interface 960 that is coupled to the system bus but may be connected by other interface and bus structures. A visual display 991 or other type of display device is also connected to the system bus 921 via an interface, such as a video interface 990. In addition to the monitor, computers may also include other peripheral output devices such as speakers 997 and printer 996, which may be connected through an output peripheral interface 995.

The computer 910 is operated in a networked environment using logical connections, such as a Local Area Network (LAN) or Wide Area Network (WAN) to one or more remote computers, such as a remote computer 980.

When used in a LAN networking environment, the computer 910 is connected to the LAN 971 through a network interface or adapter 970. When used in a WAN networking environment, the computer 910 typically includes a modem 972 or other means for establishing communications over the WAN 973, such as the Internet. In a networked environment, program modules may be stored in a remote memory storage device. FIG. 9 illustrates, for example, that remote application programs 985 can reside on remote computer 980.

In the present detailed description of the preferred embodiments, reference is made to the accompanying drawings, which illustrate specific embodiments in which the invention may be practiced. The illustrated embodiments are not intended to be exhaustive of all embodiments according to the invention. It is to be understood that other embodiments may be utilized and structural or logical changes may be made without departing from the scope of the present invention. The following detailed description, therefore, is not to be taken in a limiting sense, and the scope of the present invention is defined by the appended claims.

Unless otherwise indicated, all numbers expressing feature sizes, amounts, and physical properties used in the specification and claims are to be understood as being modified in all instances by the term “about.” Accordingly, unless indicated to the contrary, the numerical parameters set forth in the foregoing specification and attached claims are approximations that can vary depending upon the desired properties sought to be obtained by those skilled in the art utilizing the teachings disclosed herein.

As used in this specification and the appended claims, the singular forms “a,” “an,” and “the” encompass embodiments having plural referents, unless the content clearly dictates otherwise. As used in this specification and the appended claims, the term “or” is generally employed in its sense including “and/or” unless the content clearly dictates otherwise.

Spatially related terms, including but not limited to, “proximate,” “distal,” “lower,” “upper,” “beneath,” “below,” “above,” and “on top,” if used herein, are utilized for ease of description to describe spatial relationships of an element(s) to another. Such spatially related terms encompass different orientations of the device in use or operation in addition to the particular orientations depicted in the figures and described herein. For example, if an object depicted in the figures is turned over or flipped over, portions previously described as below or beneath other elements would then be above or on top of those other elements.

As used herein, when an element, component, or layer for example is described as forming a “coincident interface” with, or being “on,” “connected to,” “coupled with,” “stacked on” or “in contact with” another element, component, or layer, it can be directly on, directly connected to, directly coupled with, directly stacked on, in direct contact with, or intervening elements, components or layers may be on, connected, coupled or in contact with the particular element, component, or layer, for example. When an element, component, or layer for example is referred to as being “directly on,” “directly connected to,” “directly coupled with,” or “directly in contact with” another element, there are no intervening elements, components or layers for example. The techniques of this disclosure may be implemented in a wide variety of computer devices, such as servers, laptop computers, desktop computers, notebook computers, tablet computers, hand-held computers, smart phones, and the like. Any components, modules or units have been described to emphasize functional aspects and do not necessarily require realization by different hardware units. The techniques described herein may also be implemented in hardware, software, firmware, or any combination thereof. Any features described as modules, units or components may be implemented together in an integrated logic device or separately as discrete but interoperable logic devices. In some cases, various features may be implemented as an integrated circuit device, such as an integrated circuit chip or chipset. Additionally, although a number of distinct modules have been described throughout this description, many of which perform unique functions, all the functions of all of the modules may be combined into a single module, or even split into further additional modules. The modules described herein are only exemplary and have been described as such for better ease of understanding.

If implemented in software, the techniques may be realized at least in part by a computer-readable medium comprising instructions that, when executed in a processor, performs one or more of the methods described above. The computer-readable medium may comprise a tangible computer-readable storage medium and may form part of a computer program product, which may include packaging materials. The computer-readable storage medium may comprise random access memory (RAM) such as synchronous dynamic random access memory (SDRAM), read-only memory (ROM), non-volatile random access memory (NVRAM), electrically erasable programmable read-only memory (EEPROM), FLASH memory, magnetic or optical data storage media, and the like. The computer-readable storage medium may also comprise a non-volatile storage device, such as a hard-disk, magnetic tape, a compact disk (CD), digital versatile disk (DVD), Blu-ray disk, holographic data storage media, or other non-volatile storage device.

The term “processor,” as used herein may refer to any of the foregoing structure or any other structure suitable for implementation of the techniques described herein. In addition, in some aspects, the functionality described herein may be provided within dedicated software modules or hardware modules configured for performing the techniques of this disclosure. Even if implemented in software, the techniques may use hardware such as a processor to execute the software, and a memory to store the software. In any such cases, the computers described herein may define a specific machine that is capable of executing the specific functions described herein. Also, the techniques could be fully implemented in one or more circuits or logic elements, which could also be considered a processor.

A filter remaining capacity detection system is presented that includes a parameter retriever that retrieves parameter information for an atmosphere around the filter. The system also includes an adsorption estimate generator that, based on the parameter information retrieved, solves a set of controlling equations to generate an adsorption estimate. The controlling equations are a set of mass and energy balance equations. The system also includes a remaining capacity detector that, based on the adsorption estimate, generates a remaining capacity estimate. The system also includes an signal generator that generates an signal if the remaining capacity estimate is below a threshold.

The system may be implemented such that the adsorption estimate generator solves the set of controlling equations in substantially real time.

The system may be implemented such that the controlling equations are partial differential equations.

The system may be implemented such that the controlling equations are differential equations.

The system may be implemented such that it also includes a controller that initiates retrieval of parameter information by the parameter retriever and generation of the adsorption estimate.

The system may be implemented such that the controller automatically initiates generation, by the adsorption estimate generator, when a detected change in parameter information retrieved is higher than a threshold.

The system may be implemented such that the controller initiates retrieval periodically.

The system may be implemented such that the controller initiates retrieval once per minute.

The system may be implemented such that the controller initiates retrieval based on a user-specified time period, a manufacturer-set time period, or a worksite-wide time period.

The system may be implemented such that the retrieved parameter information is a first retrieved parameter information and the controller causes the parameter retriever to retrieve a second parameter information substantially immediately after the adsorption estimate is generated.

The system may be implemented such that the controller initiates retrieval in response to a user input.

The system may be implemented such that the controller automatically initiates retrieval in response to a trigger.

The system may be implemented such that the triggers is a detected location.

The system may be implemented such that the system is incorporated into a personal protective equipment device.

The system may be implemented such that the personal protective equipment device includes the filter.

The system may be implemented such that the system is remote from a personal protective equipment device including the filter.

The system may be implemented such that the retrieved parameter information includes a default set of parameters.

The system may be implemented such that the retrieved parameter information includes a real-time parameter value.

The system may be implemented such that the real-time parameter value is received from a sensor.

The system may be implemented such that the sensor includes a contaminant sensor, a concentration sensor, a temperature sensor, a humidity sensor, a pressure sensor or a breathing sensor.

The system may be implemented such that the sensor is a fixed sensor.

The system may be implemented such that the sensor is part of a personal protective equipment device.

The system may be implemented such that the real-time parameter value is received from a weather forecast.

The system may be implemented such that the real-time parameter value includes a user indication for a user of the filter.

The system may further include a network and a communication component that communicates over the network using a network protocol.

The system may be implemented such that the parameter retriever retrieves the parameter information over the network.

The system may be implemented such that the communication component communicates with a database over the network, and the generated adsorption estimate is stored in the database.

The system may be implemented such that parameter retriever retrieves the parameter information from the database.

The system may be implemented such that the database includes filter specifications, and the retrieved parameter information includes the filter specifications.

The system may also include a controller that automatically initiates retrieval of parameter information and adsorption generation, when a Powered Air Purifying Respirator (PAPR) filter is connected and a flow rate is detected.

The system may be implemented such that the signal is an alert that remaining adsorption capacity estimate is below a threshold.

The system may be implemented such that the retrieved parameter is a contaminant identity.

The system may be implemented such that the contaminant identity is retrieved from a contaminant sensor.

The system may be implemented such that the contaminant identity is retrieved from a datastore.

The system may be implemented such that the contaminant identity is manually input.

A method of providing a remaining capacity estimate for a filter is presented that includes retrieving a specification for a filter and a use conditions for a device including the filter. The method also includes retrieving a set of environmental parameters for a site. The method also includes initiating a remaining capacity estimator to, based on the device specification, the use condition and the set of site parameters, estimate a remaining useful life by solving a set of controlling equations. The method also includes providing the remaining useful life to a receiver.

The method may be implemented such that the controlling equations include a mass balance and an energy balance equation derived to model a mass transfer effect through a sorbent bed.

The method may be implemented such that the controlling equations include partial differential equations.

The method may be implemented such that the controlling equations include differential equations.

The method may be implemented such that the specifications for the device include filter specifications for a filter within the device.

The method may be implemented such that the environmental parameters include a temperature, a relative humidity, a pressure, a contaminant, or a contaminant concentration for the site.

The method may be implemented such that the environmental parameters include a default parameter value for the site.

The method may be implemented such that the environmental parameters include a site parameter value retrieved from a sensor within the site.

The method may be implemented such that the sensos is a fixed sensor within the site.

The method may be implemented such that the sensor is part of a personal protective equipment device.

The method may be implemented such that the device includes the sensor.

The method may be implemented such that the sensor includes a temperature sensor, a pressure sensor, a humidity sensor, a contaminant concentration sensor or a breath-rate or flow rate sensor.

The method may be implemented such that the device specifications include adsorption specifications for the filter.

The method may be implemented such that the default parameter value is an estimated value.

The method may be implemented such that the estimated value is based on a parameter history for the site.

The method may be implemented such that the estimated value is based on a user of the device.

The method may be implemented such that the estimated value is based on a weather prediction for the site.

The method may be implemented such that retrieving environmental parameters is initiated by a trigger.

The method may be implemented such that the steps of initiating and providing proceed automatically if the retrieved set of environmental parameters differ from a stored set of environmental parameters by more than a threshold.

The method may be implemented such that the set of environmental parameters includes a temperature, a relative humidity, a present contaminant, or a concentration of a present contaminant, and the steps of initiating and providing proceed automatically if a temperature threshold, a relative humidity threshold or a concentration threshold is exceeded.

The method may be implemented such that the trigger is an elapsed time since the last retrieval of environmental parameters.

The method may be implemented such that the trigger is a device powering up or powering on.

The method may be implemented such that the trigger is a detected location of the device.

The method may be implemented such that the trigger is a time of day.

The method may be implemented such that the trigger is a manual input.

The method may be implemented such that providing includes communicating, using a communication component, an indication of the remaining useful life over a network.

The method may be implemented such that the receiver is the device.

The method may be implemented such that the receiver is a second device.

The method may be implemented such that the receiver is a datastore.

The method may be implemented such that retrieving includes communicating with a datastore, over a network, using the communication component.

The method may be implemented such that the remaining capacity estimator is incorporated into the device.

The method may be implemented such that the remaining capacity estimator is remote from the device.

The method may be implemented such that retrieving includes retrieving from a datastore, and the device includes the remaining capacity estimator and the datastore.

The method may be implemented such that retrieving includes retrieving from a datastore remote from the device.

The method may be implemented such that providing the remaining capacity includes providing an alert if the remaining capacity is below a threshold.

The method may be implemented such that the alert includes a visual, an audio or a haptic feedback.

The method may be implemented such that it also includes retrieving a device use condition and the estimated remaining capacity is based on the device use condition.

A filter capacity estimation device is presented that includes a processing unit configured to, upon receipt of an estimate initiation signal. The processing unit is also configured to retrieve a set of default estimate parameters for a filter, update the set of default estimate parameters, and generate an estimated remaining filter capacity by solving a set of control equations including the updated set of default estimate parameters. The device also includes a feedback generator that generates a feedback signal indicative of the estimated remaining filter capacity.

The device may be implemented such that the set of control equations include differential equations.

The device may be implemented such that the differential equations include partial differential equations.

The device may be implemented such that it also includes a display component, and the feedback signal includes a graphical user interface that includes a concentration distribution for the filter.

The device may be implemented such that the concentration distribution is presented as a percentage used.

The device may be implemented such that the concentration distribution is presented as a graphic.

The device may be implemented such that the concentration distribution is presented graphically.

The device may be implemented such that the feedback signal is an audible alarm.

The device may be implemented such that the feedback signal is a visible indication.

The device may be implemented such that the feedback signal is a haptic feedback.

The device may be implemented such that it also includes a communication component that communicates the feedback signal to a second device.

The device may be implemented such that the second device includes the filter.

The device may be implemented such that the second device is remote from the filter capacity estimation device.

The device may be implemented such that the second device includes a datastore.

The device may be implemented such that the datastore includes a historic site parameter value.

The device may be implemented such that updating the set of default estimate parameters includes retrieving a real site parameter value, and replacing a corresponding estimate site parameter value with the real parameter value.

The device may be implemented such that the real site parameter value is retrieved from a sensor.

The device may be implemented such that the filter capacity estimation device includes the sensor.

The device may be implemented such that the real site parameter value is retrieved over a network from a second device.

The device may be implemented such that the real site parameter value is retrieved from a datastore.

The device may be implemented such that the real site parameter is retrieved from a second device.

The device may be implemented such that the real site parameter is manually input.

The device may be implemented such that the estimate initiation signal causes the processing unit to retrieve and update periodically.

The device may be implemented such that periodically includes retrieving and updating substantially continuously.

The device may be implemented such that the estimate initiation signal causes the processing unit to retrieve and update at device power up or power on.

The device may be implemented such that the set of control equations is solved substantially in real time.

The device may be implemented such that a graphical user interface provides the feedback estimate with a concentration distribution.

The device may be implemented such that the graphical user interface updates the concentration distribution for the filter substantially in real time.

The device may be implemented such that, once the set of control equations is solved, the processing unit repeats the steps of retrieving, updating and solving.

The device may be implemented such that an iteration of retrieving, updating and solving is completed within one minute.

The device may be implemented such that a repeat period is a user-specified repeat period, a manufacturer-set repeat period, or a worksite-wide repeat period.

The device may be implemented such that the feedback generator sends the feedback signal to filter when estimated remaining filter capacity is below a threshold.

The device may be implemented such that the display component includes a graph of information retrieved for the filter.

The device may be implemented such that a filter specification is retrieved, and the estimated remaining filter capacity is based on the retrieved filter specification.

A filter use simulation system is presented that includes a simulation initiator that receives a simulation command from a requesting device. The system also includes a parameter retriever that retrieves a filter specification for a filter and an atmosphere specification for a site. The system also includes a remaining capacity estimate generator that, based on the filter specification and the atmosphere specification, generates a remaining capacity estimate for the filter by solving a set of controlling equations. The system also includes a communication component that communicates the remaining capacity estimate to the requesting device.

The system may be implemented such that the set of controlling equations includes differential equations.

The system may be implemented such that the set of controlling equations includes partial differential equations.

The system may be implemented such that the atmosphere specification is an estimated parameter value for the site.

The system may be implemented such that the estimated parameter is stored in a datastore.

The system may be implemented such that the estimated parameter is based on historic parameter values.

The system may be implemented such that the estimated parameter is based on a known value.

The system may be implemented such that the known value is a contaminant concentration at a first location, and the estimated parameter is an estimated contaminant concentration at a second location.

The system may be implemented such that the known value is a user gender, height, weight or heart rate and the estimated parameter is an estimated breath rate or flow rate.

The system may be implemented such that the atmosphere specification is a sensed parameter value for the site.

The system may be implemented such that the sensed parameter value includes a site temperature, site pressure, site humidity, site contaminant concentration, or user breath rate, or filter flow rate.

The system may be implemented such that the sensed parameter value is received from a sensor.

The system may be implemented such that the sensed parameter value is received from the requesting device.

The system may be implemented such that the requesting device is a personal protective equipment device including the filter.

The system may be implemented such that the system also includes a storage that stores the remaining capacity estimate, for the filter.

The system may be implemented such that the system also includes a profile generator that generates a site profile based on stored atmosphere specifications.

The system may be implemented such that the adsorption estimate generator solves the set of controlling differential equations in substantially real time.

The system may be implemented such that the communication component communicates to the filter when the remaining capacity estimate is below a threshold.

The system may be implemented such that the atmosphere specification is a present contaminant.

The system may be implemented such that the present contaminant is retrieved from a sensor.

The system may be implemented such that the present contaminant is retrieved from a datastore.

The system may be implemented such that the present contaminant is manually entered.

A filter use monitoring system for a site is resented that includes a respirator with a filter configured to be worn by a user in the site. The system also includes a datastore. The datastore includes site condition information including a concentration of an adsorbable material in the atmosphere of the site. The datastore also includes filter specification information and a filter use simulator that, based on the site condition information and the filter specification information, solves a set of controlling equations to generate an estimated remaining capacity indication. The system also includes a communications component that communicates the estimated remaining capacity indication to a receiving device.

The system may be implemented such that the datastore is remote from the respirator.

The system may be implemented such that the filter use simulator is remote from the respirator.

The system may be implemented such that the site condition information includes a sensor signal retrieved from a sensor in the site.

The system may be implemented such that the site condition information also includes an atmosphere condition retrieved from a weather forecast.

The system may be implemented such that the datastore also includes a default set of atmosphere conditions for the site for use by the filter use simulator in the absence of sensed real-time atmospheric conditions.

The system may be implemented such that it also includes a parameter retriever that retrieves sensed real-time atmospheric conditions.

The system may be implemented such that the retrieved sensed real-time atmospheric conditions are retrieved from a site sensor over a site network.

The system may be implemented such that the filter use simulator estimates an atmosphere condition based sensed real-time atmospheric conditions retrieved from a site sensor over a site network.

The system may be implemented such that the estimated atmospheric condition is based on a respirator location signal and a sensor location signal.

The system may be implemented such that the sensed real-time atmospheric condition is based on a weather forecast for the site.

The system of may be implemented such that the receiving device is the respirator.

The system may be implemented such that the receiving device is a personal protective equipment device.

The system may be implemented such that the receiving device includes a computing device.

The system may be implemented such that the receiving device includes a display component. The estimated remaining filter capacity is communicated as a graphical user interface for display on the display component.

The system may be implemented such that the system also includes an initiator that causes the filter use simulator to retrieve an updated site condition information and generate an estimated remaining capacity indication based on the updated site condition.

The system may be implemented such that the initiator actuates based on an elapsed time.

The system may be implemented such that the initiator actuates based on a communication from the receiving device or the respirator.

The system may be implemented such that the filter use simulator solves the set of controlling equations in substantially real time.

The system may be implemented such that the filter use simulator solves the set of controlling equations each time a new site condition information is obtained.

The system may be implemented such that the filter use simulator scans for new site condition information periodically.

The system may be implemented such that periodically includes once per minute.

The system may be implemented such that periodically includes continuously.

The system may be implemented such that the site condition is a present contaminant retrieved from a datastore, a sensor, or a manual input.

A residual life system is presented that includes a residual life estimate receiver that receives a remaining capacity estimate from a residual life calculator. The remaining capacity estimate includes a timestamp and an indication of filter adsorption capacity for a filter. The system also includes a datastore that stores the remaining capacity estimate with the timestamp and filter adsorption capacity indication.

The system may be implemented such that the remaining capacity estimate receiver continuously checks for a residual life estimate from the remaining capacity calculator.

The system may be implemented such that the datastore compares the received residual life estimate to a previously received remaining capacity estimate or to a set of previously received residual life estimate.

The system may be implemented such that the remaining capacity estimate receiver receives a first remaining capacity estimate, for a first filter, and a second or more remaining capacity estimates, for a second or more filters.

The system may be implemented such that the first remaining capacity estimate is compared to the second or more remaining capacity estimates.

The system may be implemented such that, if the comparison exceeds a threshold, an alert is generated.

The system may be implemented such that the alert is communicated, using an alert communicator, to a device.

The system may be implemented such that the device includes a display. The alert is presented on the display.

The system may also include a remaining capacity estimate communicator that, in response to a request, communicates a most recently received residual life estimate.

The system may be implemented such that the request is received from a device.

The system may be implemented such that the remaining capacity estimate receiver of claim 1 communicates over a network.

The system may be implemented such that the datastore further includes a filter parameter.

The system may be implemented such that the datastore further includes a site parameter.

The system may be implemented such that the datastore further includes a user parameter.

The system may be implemented such that the remaining capacity system also includes a parameter provider that, in response to a request from the remaining capacity estimate, provides a parameter value.

### Examples

### Example 1: Simulating with Default Parameters

A set of default simulation parameters are pre-populated into an MCU and stored in a set of nonvolatile memory. A computer running the simulation software allows the user to configure and edit the simulation parameters. The parameters can be entered either from the manufacturing (fixed database), entered manually, or downloaded from the vendor's online service website. The filter parameters include the following information:
1. Information of filters, e.g. type or class of filter, shape of filter, inlet/outlet size, bed depth, carbon volume, and carbon packing density
2. Information of chemicals, e.g. chemical molecular weights, vapor pressure models, exposure limit and IDLH concentration, molar polarization, liquid density
3. Information of the sorbent; e.g particle size, apparent density, equilibrium capacity
4. Default operation conditions, e.g. site contaminants and concentrations, site temperature, site relative humidity, barometric pressure, and flow rate for a negative pressure respirator (e.g. average breathing rate and tidal volume, obtainable from OSHA based on a known worker's age, gender, height, weight and work load; or obtained from sensors such as the Bioharness from Medtronic or the Equivital physiological sensor. or flow rate in a positive pressure respirator such as PAPR),

The mobile simulation device is equipped with some nonvolatile memory to store the above information (hereafter referred to as mobile database).

The software has a window where the user can estimate the variation of operations parameters throughout the working period, e.g. an 8 hour period. The parameters are estimated to the best knowledge of the user of the work session conditions, as well as the best estimate of the ambient conditions at the workplace. For example, the temperature and relative humidity variation can be estimated and adjusted based on local weather forecast or knowledge of the controlled indoor environment. The flow rate can be estimated based on the task arrangement of the workday, e.g., when user is in heavy working condition, when the user is at rest wearing the respirator, when the user is at a break taking the mask off (e.g. at a lunch break).). If a blower is used it can be estimated by the blower speed during operation. The site concentrations can be estimated based on the task arrangement of the day, e.g. at what time periods the wearer is expected to experience what concentrations. These could be different concentrations at a fixed site, or at different sites the wearer is expected to work at.

Although such estimation may not be accurate, it helps provide better simulation accuracy than a fixed constant set of site conditions.

The software can store the information and run the simulation, which provides visualization of the remaining capacity at various time. Also, it can be connected to a wearable device and upload the parameters to the wearable device where the simulation algorithm is prepopulated and run based on the uploaded parameters. This wearable device may be attached to the respirator, such as a Heads-up Display unit (HUD), or a hand-held electronic device such as a smart phone. In some embodiment, the wearable device may connect directly to the internet to obtain certain parameters, and parameters can also be edited on the said wearable device without the need of the said computer.

### Example 2: Simulation with Real Time Weather Condition

In this implementation, the real-time weather conditions (temperature and relative humidity) are provided to the software which overrides the default weather conditions. The weather conditions can be obtained from a built-in relative humidity/temperature sensor, or from the input from a local weather broadcasting channel (e.g. from the weather service of a smart phone). The corrected weather conditions help the software to better simulate the process and provide a more accurate output. For example, a temperature may vary throughout the day in an outdoor environment. An average temperature may be 26° C., which could be used as a default. A sensor may report changing temperature conditions, starting at 20° C. in the morning and rising to 30° C. by early afternoon before quickly dropping to 25° C. as rain falls. Average relative humidity may be 70%, which could be used as a default. A sensor may report changing relative humidity conditions, starting at 70% in the morning, rising in the afternoon and hitting 100% as rain falls. These changing conditions can significantly change how quickly a filter experiences loading.

### Example 3: Simulation with Real Time Breathing Flow Sensor

In this implementation, the real-time breathing rate information (averaged flow rate and/or instantaneous flow rate) are provided to the software which overrides the flow rate. The flow rate can be obtained from a built-in flow sensor, a breathing monitor sensor such as the Bioharness, or from the manual input from the wearer. The corrected flow rate helps the software to better simulate the process and provide more accurate outputs. For example, a breathing rate can vary from as low as 10 liters/minute, for light activity, to up to 135 liters/minute, and a blower rate may vary from 160 liters/minute to 230 liters/minute for heavy activity (ISO 17420-2:2021). Because of the wide variation, it is difficult to estimate breathing rate accurately during a workshift. Including breathing rate information is likely to greatly improve the accuracy of the simulation.

### Example 4: Simulation with Real Time Chemical Sensor

If information is available from an onsite chemical detector, this information is provided to the software which overrides the default chemical concentration. This can be from a built-in chemical sensor, a wireless communication with a fixed-site chemical detector or hand-held chemical detector, a chemical concentration broadcasting, or from the manual input of the user. For example, Xylene exposure is considered safe at around 100 ppm, but not safe if at levels of 150 ppm for a 15 minute work period. But Xylene concentration may vary within a worksite, for example 220 ppm near a Xylene storage and use area, but only 120 ppm in another area of the worksite. Knowing the concentration where a worker is provides more accurate information about the current capacity rate.

### Example 5: Filter Adsorption Capacity Simulation for a Filter Cartridge Unit with Multi-Layer Sorbent Materials

In this example we describe a filter adsorption capacity simulation where the filter cartridge comprises three different sorbent materials placed as layers in the filter cartridge. Each layer has preferential affinity to a specific chemical or contaminant in the air. Example chemicals include (but are not limited to) toluene, benzene, xylene, hydrogen sulfide, hydrochloric acid, ammonia and the like. Typically, the contaminant chemicals are present in work sites in the form of organic and inorganic gas and vapors and when inhaled they pose a health risk to the worker. Therefore, OSHA requires that workers present in areas that contain hazardous chemicals at levels above the exposure limit wear respiratory protection with organic vapor capturing filters.

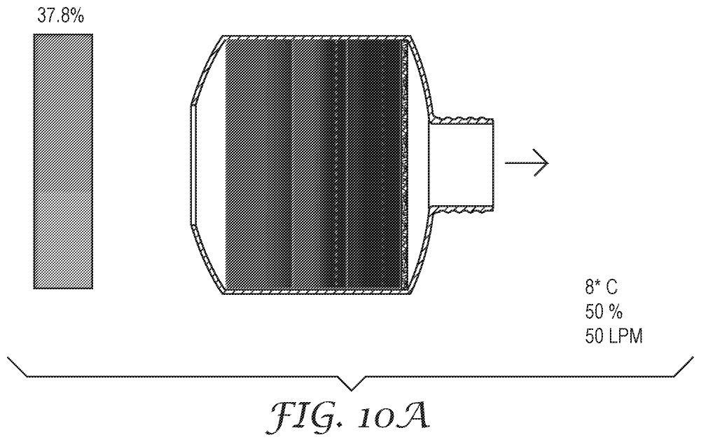

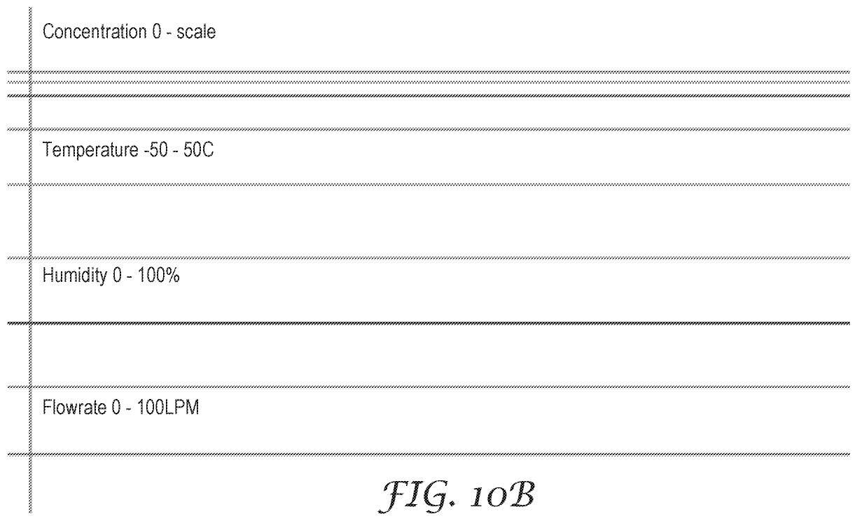

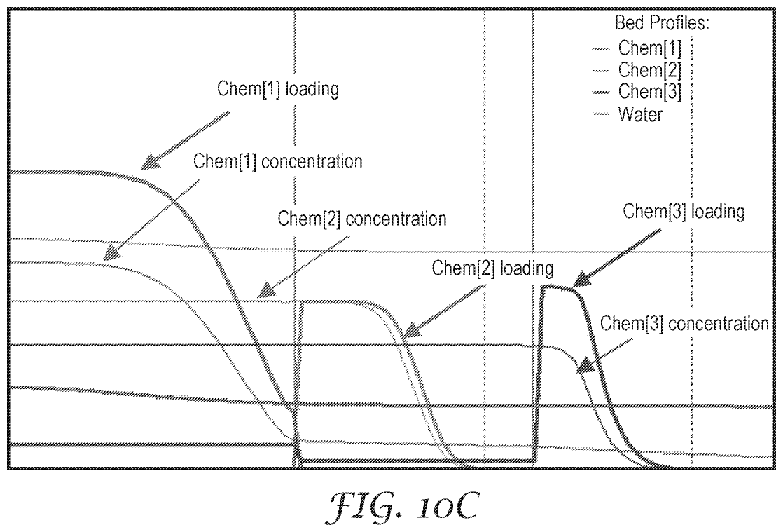

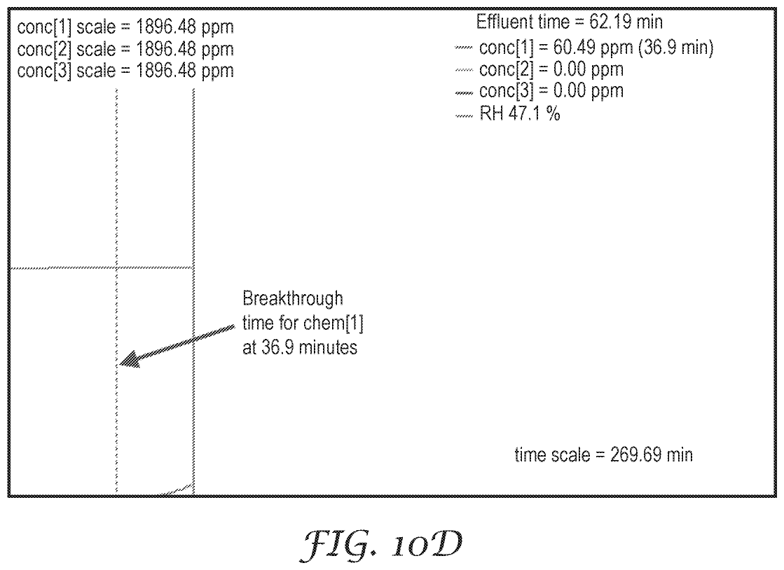

In this example the filter comprises three different sorbent materials as shown in FIG. 10A (here the three sorbent materials are colored red, green and blue but I will code them with numbers 1, 2 and 3). The arrow indicates the inhaled air flow direction across the sorbent bed in the filter.

The software simulation provides real time data on the estimated remaining adsorption capacity of the filter as shown in the bar, in this example it is 37.8%. The estimate is based in input parameters into the software where the input parameters are shown in FIG. 10A, those include the concentration of three known chemical contaminants, designated as Chem1, Chem 2 and Chem 3 in the figure. The values were either known for the work area or measured in real time using single or multi-gas detectors such as the Altair 4xr Multi-Gas detector available from MSA Technologies (msatechnologies.com). In FIG. 10A the concentrations in ppm (parts per million) are displayed as follows: chem 1: 851 ppm, chem 2: 691 ppm and chem 3: 514 ppm. Other input parameters include ambient conditions: Temperature=8° C. and 50% relative Humidity. The breathing rate (air flow rate) is measured or estimated to be 50 LPM (liters per minute).

In this example the sorbent bed is designed such that each different layer has preferential adsorption efficiency to one of the three chemicals. Layer 1 has stronger adsorption affinity to chemical 1, layer 2 has stronger adsorption affinity to chemical 2 and layer 3 has stronger adsorption affinity to chemical 3.

FIG. 10B shows the acceptable range of the input parameters. The concentration of chemicals in the air can range from 0 to any level possible in the workplace, designated in ppm. The temperature can range from −50C to 50C, the relative humidity can range from 0%-100% and the air flow rate across the sorbent bed can range from 0 to 100 LPM.

FIG. 10C is a graph where the x-axis depicts the position across the filter bed and the Y-axis is the concentration. FIG. 10C depicts the change in the concentration of three different chemicals in the air and the loading of the same chemicals in the sorbent bed as the contaminated air flows across the sorbent bed. Chemical 1 is adsorbed preferentially into layer 1 of the sorbent bed reducing its concentration in the air and increasing its loading in the sorbent bed. Chemical 2 is adsorbed preferentially into layer 2 of the sorbent bed, so its concentration in the air is reduced next while its loading is increased. Chemical 3 is adsorbed preferentially into layer 3 of the sorbent bed, so its concentration in the air is reduced last while its loading is increased in the sorbent bed. Note that all three chemicals can be adsorbed into any of the layers, so if layer 1 reaches its loading capacity, some of chemical 1 may still get adsorbed into layer 2 or layer 3 if there is capacity left in those layers just not as efficiently.

A useful attribute of this example is that when layer 1 is depleted reaching its full adsorption capacity of chemical 1, and a suitable alert is provided, the worker has the option of moving to a different work area where the atmosphere does not contain chemical 1 but contains chemical 2 and/or chemical 3. Depending on preferences and safety requirements, it may be possible for the worker to continue work without the need to change out the filter cartridge. However, it is expressly contemplated that, for some contaminants, it is recommended to change out the filter cartridge as soon as any of layers 1, 2, or 3 are depleted.

FIG. 10D provides the data at a time of 62.19 minutes from the initiation of the simulation. Where at that time the concentration of chemical 1 is 60.49 is the air exiting the sorbent bed indicating a breakthrough. The breakthrough time for chemical 1 according to the simulation is 36.9 minutes meaning that at that time the sorbent material adsorbing chemical 1no longer has the capacity to adsorb all of the influent chemical, therefore, it concentration when it exits the filter is not zero. On the other hand, the concentrations of chemicals 2 and 3 are zero (or near zero) since their respective sorbent material is not depleted and no breakthrough occurred.

In FIG. 10D the concentration scale of 1896.48 ppm indicates the Y-axis scale for all three chemicals.

### Example 6: Simulation with a PAPR

PAPR filter typically has built-in sensors for flow rate controlling. If information such as battery usage, blower speed setting, particulate filter loading status is already available on a PAPR unit, the information can be retrieved and provided to the simulation software. The flow rate through filter sorbent bed can be either estimated based on those information and headgear fit (e.g. loose fit or tight fit) or retrieved based on claim by PAPR manufacturer. The simulation software then uses it in place of a person's breathing rate to model the contaminant concentration profile in sorbent bed.

Additionally, for belt mounted PAPR units, such as that illustrated in U.S. Pat. No. 10,610,708, issued on Apr. 7, 2020, wherein the PAPR is worn at the back of a wearer who, therefore, cannot see PAPR's own display, the retrieved PAPR information can be displayed along with contaminant concentration profile on a portable device.

When the simulation software predicts the breakthrough, it can send signal back to the PAPR unit and rely on PAPR's built-in alert system such as vibration and audio signals to alert wearer.

1. A filter remaining capacity detection system comprising:
a parameter retriever that retrieves parameter information for an atmosphere around the filter;
an adsorption estimate generator that, based on the parameter information retrieved, solves a set of controlling equations to generate an adsorption estimate, wherein the controlling equations are a set of mass and energy balance equations;
a remaining capacity detector that, based on the adsorption estimate, generates a remaining capacity estimate; and
an signal generator that generates an signal if the remaining capacity estimate is below a threshold.

2. The system of claim 1, and further comprising:
a controller that initiates retrieval of parameter information by the parameter retriever and generation of the adsorption estimate.

3. The system of claim 2, wherein the controller automatically initiates generation, by the adsorption estimate generator, when a detected change in parameter information retrieved is higher than a threshold.

4. The system of claim 2, wherein the controller initiates retrieval periodically.

5. The system of claim 4, wherein the retrieved parameter information is a first retrieved parameter information and wherein the controller causes the parameter retriever to retrieve a second parameter information substantially immediately after the adsorption estimate is generated.

6. The system of claim 1, wherein the system is incorporated into a personal protective equipment device.

7. The system of claim 6, wherein the personal protective equipment device comprises the filter.

8. The system of claim 1, and further comprising:
a controller that automatically initiates retrieval of parameter information and adsorption generation, when a Powered Air Purifying Respirator (PAPR) filter is connected and a flow rate is detected.

9. The system of claim 1, wherein the signal is an alert that remaining adsorption capacity estimate is below a threshold.

10. A method of providing a remaining capacity estimate for a filter, the method providing:
retrieving a specification for a filter and a use condition for a device comprising the filter;
retrieving a set of environmental parameters for a site;
initiating a remaining capacity estimator to, based on the device specification, the use condition and the set of site parameters, estimate a remaining useful life by solving a set of controlling equations; and
providing the remaining useful life to a receiver.

11. The method of claim 10, wherein the controlling equations comprise a mass balance and an energy balance equation derived to model a mass transfer effect through a sorbent bed.

12. The method of claim 10, wherein the specifications for the device comprise filter specifications for a filter within the device.

13. The method of claim 10, wherein the environmental parameters comprise a temperature, a relative humidity, a pressure, a contaminant, or a contaminant concentration for the site.

14. The method of claim 10, wherein the device specifications comprise adsorption specifications for the filter.

15. The method of claim 10, wherein the steps of initiating and providing proceed automatically if the retrieved set of environmental parameters differ from a stored set of environmental parameters by more than a threshold.

16. The method of claim 10, wherein the remaining capacity estimator is incorporated into the device.

17. (canceled)

18. A filter use monitoring system for a site, the system comprising:
a respirator with a filter configured to be worn by a user in the site;
a datastore comprising:
site condition information comprising a concentration of an adsorbable material in the atmosphere of the site; and
filter specification information;
a filter use simulator that, based on the site condition information and the filter specification information, solves a set of controlling equations to generate an estimated remaining capacity indication; and
a communications component that communicates the estimated remaining capacity indication to a receiving device.

19. The system of claim 18, and further comprising a parameter retriever that retrieves sensed real-time atmospheric conditions and wherein the filter use simulator estimates an atmosphere condition based sensed real-time atmospheric conditions retrieved from a site sensor over a site network.

20. The system of claim 18, wherein the filter use simulator solves the set of controlling equations each time a new site condition information is obtained.
